(19) United States
(12) Patent Application Publication
(10) Pub. No.: US 2021/0027146 A1
(43) Pub. Date: Jan. 28, 2021

(54) METHOD AND APPARATUS FOR DETERMINING INTEREST OF USER FOR INFORMATION ITEM

(71) Applicant: Tencent Technology (Shenzhen) Company Limited, Shenzhen (CN)

(72) Inventors: Cong XU, Shenzhen (CN); Mingyuan MA, Shenzhen (CN)

(73) Assignee: Tencent Technology (Shenzhen) Company Limited, Shenzhen (CN)

(21) Appl. No.: 17/071,761

(22) Filed: Oct. 15, 2020

Related U.S. Application Data
(63) Continuation of application No. PCT/CN2019/109927, filed on Oct. 8, 2019.

(30) Foreign Application Priority Data
Oct. 23, 2018 (CN) 201811233142.7

(51) Int. Cl. G06N 3/04; G06Q 30/02; G06N 3/08

(52) U.S. Cl. CPC G06N 3/0472; G06Q 30/0201; G06Q 30/0631; G06N 3/08; G06N 3/0445

(57) ABSTRACT

The present disclosure provides a method and an apparatus for determining interest of a user for an information item, a computer device, and a computer-readable storage medium. The method includes obtaining, according to behaviors of a plurality of behavior classifications of a target user, a classification behavior information representation including vectorized information of behaviors of each behavior classification of the target user; obtaining a vectorized information representation of a candidate information item; and determining interest of the target user for the candidate information item according to the classification behavior information representation of the behaviors of the target user and the vectorized information representation of the candidate information item.

### RELATED APPLICATION

The present application is a continuation of the PCT International Patent Application No. PCT/CN2019/109927, filed with the National Intellectual Property Administration, PRC on Oct. 8, 2019 which claims priority to Chinese Patent Application No. 201811233142.7, filed with the National Intellectual Property Administration, PRC on Oct. 23, 2018 and entitled “METHOD AND APPARATUS FOR DETERMINING INTEREST OF USER FOR INFORMATION ITEM, DEVICE, AND STORAGE MEDIUM”, which are incorporated by reference in their entireties.

### FIELD OF THE TECHNOLOGY

The present disclosure relates generally to the field of Internet technologies and specifically to a method and an apparatus for determining interest of a user for an information item.

### BACKGROUND OF THE DISCLOSURE

A recommendation system is widely applied to Internet products. The recommendation system usually determines or predicts user preference/interest based on big data and an algorithm, and recommends an information item satisfying the user preference/interest as much as possible, to improve a recommendation success rate. A common recommendation method may be divided into three types: content-based recommendation, collaborative filtering-based recommendation, and cross-hybrid recommendation.

### SUMMARY

One of objectives of the present disclosure is to provide a method and an apparatus for determining interest of a user for an information item, a computer device, and a computer-readable storage medium, to resolve one or more of the foregoing problems.

According to a first aspect of embodiments of the present disclosure, a method for determining interest of a user for an information item is disclosed and performed by a computer device. The method may include obtaining, according to behaviors of a plurality of behavior classifications of a target user, a classification behavior information representation including vectorized information of behaviors of each behavior classification of the target user; obtaining a vectorized information representation of a candidate information item; and determining interest of the target user for the candidate information item according to the classification behavior information representation of the behaviors of the target user and the vectorized information representation of the candidate information item.

According to a second aspect of the embodiments of the present disclosure, a computer device for determining interest of a user for an information item is disclosed. The computer device may include a memory for storing instructions and a processor. The processor, when executing the instructions, may be configured to obtain, according to behaviors of a plurality of behavior classifications of a target user, a classification behavior information representation including vectorized information of behaviors of each behavior classification of the target user; obtain a vectorized information representation of a candidate information item; and determine interest of the target user for the candidate information item according to the classification behavior information representation of the behaviors of the target user and the vectorized information representation of the candidate information item.

According to a third aspect of the embodiments of the present disclosure, a non-transitory computer-readable storage medium is disclosed for storing a computer program, the computer program, when executed by a processor, implementing the method in the foregoing embodiments.

### BRIEF DESCRIPTION OF THE DRAWINGS

Through detailed description of exemplary embodiments of the present disclosure with reference to the accompanying drawings, the foregoing and other objectives, features, and advantages of the present disclosure will become clear. The accompanying drawings of the present disclosure are incorporated into the specification and constitute a part of this specification. The accompanying drawings exemplarily show embodiments suitable for the present disclosure, and together with the specification are used to explain the principle of the present disclosure.

FIG. 1 is a schematic diagram of an implementation environment involved in the present disclosure according to an exemplary embodiment of the present disclosure.

FIG. 2 is a schematic flowchart of a method for determining interest of a user for an information item according to an exemplary embodiment of the present disclosure.

FIG. 3 is a schematic flowchart of an example of a specific implementation of step S210 of the method embodiment shown in FIG. 2.

FIG. 4 is a schematic flowchart of an information vectorization method according to an exemplary embodiment of the present disclosure.

FIG. 5 is a schematic diagram of relationship data recorded in the form of a relationship list according to an exemplary embodiment of the present disclosure.

FIG. 6 is a schematic diagram of relationship data recorded in the form of an interactive map according to an exemplary embodiment of the present disclosure.

FIG. 7 is a schematic flowchart of an example implementation of step S430 of the information vectorization method embodiment shown in FIG. 4.

FIG. 8 is a schematic flowchart of another example implementation of step S430 of the information vectorization method embodiment shown in FIG. 4.

FIG. 9 is a schematic diagram of re-representing, by a neural network, an inputted entity vector representation according to an exemplary embodiment of the present disclosure.

FIG. 10 is a schematic flowchart of an example implementation of step S230 of the method embodiment shown in FIG. 2.

FIG. 11 is a schematic flowchart of an example implementation of step S1010 of the method embodiment shown in FIG. 10.

FIG. 12 is a schematic diagram of composition of a neural network applicable to the present disclosure according to an exemplary embodiment.

FIG. 13 is a schematic flowchart of an example implementation, based on the neural network shown in FIG. 12, of step S1010 of the method embodiment shown in FIG. 10.

FIG. 14 is a schematic flowchart of an example implementation of step S1010 of the method embodiment shown in FIG. 10.

FIG. 15 is a schematic flowchart of another example implementation of step S1010 of the method embodiment shown in FIG. 10.

FIG. 16 is a schematic component block diagram of an apparatus for determining interest of a user for an information item according to an exemplary embodiment of the present disclosure.

FIG. 17 is a schematic component block diagram of a computer device according to an exemplary embodiment of the present disclosure.

### DESCRIPTION OF EMBODIMENTS

Some block diagrams shown in the accompany drawings are functional entities and do not necessarily correspond to physically or logically independent entities. Such functional entities may be implemented in the form of software, or implemented in one or more hardware modules or integrated circuits, or implemented in different networks and/or processor apparatuses and/or microcontroller apparatuses.

In the foregoing and following descriptions of the present disclosure, the term “item” or “information item”, used interchangeably, may refer to any item that may be recommended to a user, for example, a product (for example, various commodities or non-sale items, materials, and services), and content (for example, news, microblog, advertisements, documents, web pages, and other data). The term “interest” may refer to a preference level and a degree of interest of a user for an item, a probability of taking an action, or the like.

For example, in the field of news recommendation, there are the following several personalized intelligent recommendation methods: analyzing a user log, obtaining a hobby tag of a user, and recommending a news product in which the user is interested to the user through the tag; making a recommendation based on a similarity, that is, calculating a similarity between a user and a product in a manner of calculating a cosine similarity in a vector space or another manner, and adding the product to a recommendation sequence if the similarity is greater than a specified threshold; and analyzing a product and a personal feature of a user, and predicting a click-through rate (CTR) of the product based on a machine learning method.

With the constant deepening of an interaction mode in Internet product recommendation, dimensions such as users, content and products are constantly interacting with accelerating integration. In such a background, recommending a news product to a user by updating a tag has advantages of being simple and highly efficient. However, a personalized effect is poor, tag definition is broad, an inherent preference feature of the user for news cannot be accurately or fully reflected, and impact of noise is obvious. Similarity-based recommendation is beneficial to providing compelling recommendation and explanation. However, if there are many users, cost of calculation of a similarity matrix is very high, and there is a problem of data sparseness. A click-through rate of a product is predicted based on a machine learning method, recommendation is intuitive, and no field knowledge is required. However, a recommendation result directly depends on selection of features, and only a click of a user on the product is mostly used as a modeling input.

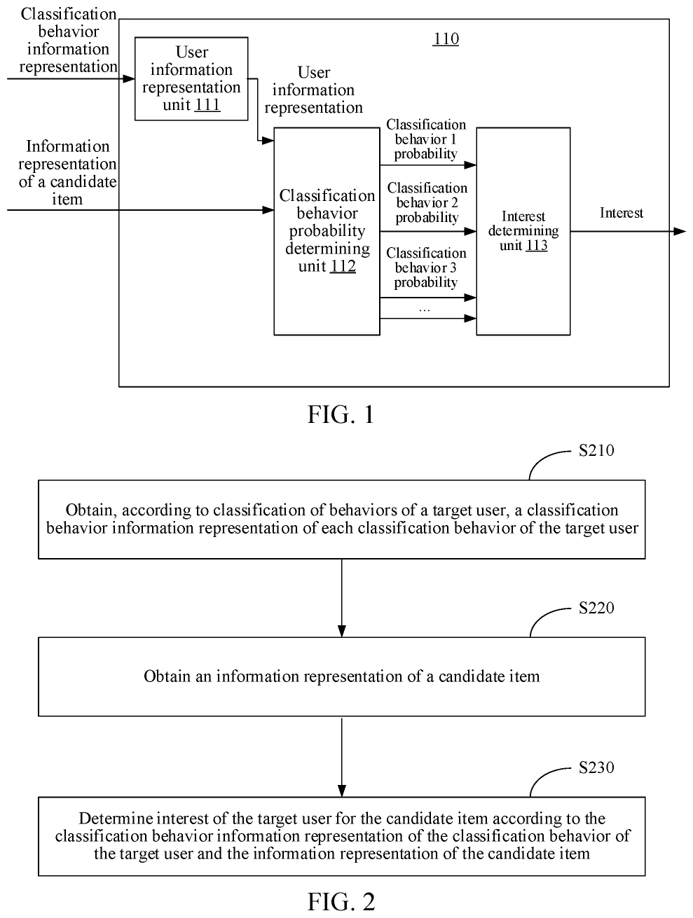

FIG. 1 is a schematic diagram of an implementation environment involved in the principle of the present disclosure according to an exemplary embodiment of the present disclosure. A method for determining interest of a user for an item and a user information vector representation method according to the embodiments of the present disclosure may be implemented in a computer device 110 shown in FIG. 1. Likewise, an apparatus for determining interest of a user for an item and a user information vector representation apparatus according to the embodiments of the present disclosure may be implemented as the computer device 110 or a part of the computer device 110 shown in FIG. 1. In the embodiment shown in FIG. 1, the computer device 110 may output interest of a target user for a candidate item according to a classification behavior information representation of the target user and an information representation of the candidate item as input. In one or more of the embodiments of the present disclosure, behaviors of the user (alternatively referred to as user action) may be classified, for example, into click, browse, purchase, and comment; or in another example, into click, comment, like, repost, and follow. In an example, the classification behavior information representation includes one of more classification behavior vector sequences, that is, each behavior is represented by a vector, and a vector sequence of each type of classification behaviors is formed by vectors of a plurality of classification behaviors of that type arranged in order of occurrence time. In some examples, a vector representation of an object (that is, an item) targeted by each behavior may be directly used as a vector in the corresponding classification behavior vector sequence. Therefore, a classification behavior vector sequence of each behavior classification of a user may be a vector sequence formed by arranging vector representations of items used as classification behavior objects in chronological order of occurrence of the classification behaviors. In an example, an item information representation includes an item vector representation. In the foregoing or following description, the classification behavior vector sequence is an example of the classification behavior information representation, that is, a classification behavior is represented by the vector sequence described above, and the item vector representation or the vector representation of the item is also an example of the item information representation. It is to be understood that any other appropriate information representation manner (other than vector representation) may also be used.

In an example, as shown in FIG. 1, the computer device 110 may include a user information representation unit 111, a classification behavior probability determining unit 112, and an interest determining unit 113. The user information representation unit 111 determines an information representation of a user (for example, a vector representation of a user) according to the inputted classification behavior information representation (for example, one or more classification behavior vector sequences). The classification behavior probability determining unit 112 determines, according to the information representation of the user and an information representation of a candidate item, a corresponding probability (as shown in FIG. 1, a classification behavior 1 probability, a classification behavior 2 probability, a classification behavior 3 probability, . . . ) that the user performs each classification behavior on the candidate item. The interest determining unit 113 comprehensively determines interest of the user for the candidate item according to corresponding probabilities for all classification behaviors. As shown in FIG. 1, the information representation of the user, the probabilities for the classification behaviors, and the interest of the user for the candidate item may each be used as an output of the computer device 110.

In an example, the computer device 110 may be connected to another device through a network or another communication medium, and receive a classification behavior vector sequence of a user and a vector representation of a candidate item from the another device. In another example, the computer device 110 may generate a classification behavior vector sequence according to information such as historical behavior data of a user, and generate a vector representation of a candidate item according to related information such as an attribute feature of the candidate item.

The computer device 110 may be any device that can realize functions such as the generating or determining a classification behavior information representation of a user, an item information representation, an information representation of a user, a classification behavior probability, and interest described above, and other functions such as communication functions. In an example, the computer device 110 may be a server device, for example, an application server device (for example, a server device for a shopping application, a server device for a search application, a server device for a social application, or a server device for a news application), or a website server device (for example, a server device for a shopping website, a search website, a social website, or a news website). In another example, the computer device 110 may be a terminal device such as a computer, a mobile terminal device, or a tablet computer, terminal APPs such as a shopping APP, a search APP, a social APP, and a news APP may be installed/run on the terminal device, and a candidate item may be a product, content or the like on the APPs.

The vector representation of the user, the probability for each classification behavior, and the interest of the user for the candidate item that are generated by the computer device 110 may be used by other units/modules in the computer device 110, or may be transmitted to another device out of the computer device 110 for further use or processing. For example, the vector representation of the user, the probability for each classification behavior, and the interest of the user for the candidate item may be further used in content recommendation/item recommendation/social relationship recommendation. For example, the probability for each classification behavior and the interest may be used in news recommendation, to resolve an experience problem of recommendation in an interactive scenario, or may be applied to a search scenario, to improve a recommendation success rate.

FIG. 2 is a schematic flowchart of a method for determining interest of a user for an item according to an exemplary embodiment of the present disclosure. The exemplary method may be performed by the computer device 110 described above. As shown in FIG. 2, the exemplary method may include the following steps.

S210. Obtain, according to classification of behaviors of a target user, a classification behavior information representation of classification behaviors of the target user.

The “target user” refers to a user whose information representation needs to be determined or whose interest for an item needs to be determined, or a user to which an item needs to be recommended.

There may be various types of behaviors of the user for the item, for example, for a product, may include: click, browse, purchase, comment, and the like, or in another example, for content, may include: click, comment, like, repost, follow, and the like. In the related art, only one behavior (for example, click) is usually considered when the information representation of the user is determined, the interest of the user is determined, or the item is recommended to the user, or although a plurality of behaviors are considered, the behaviors of the user are not classified and do not form a classification behavior information representation (for example, a classification behavior vector sequence). The inventor of the present disclosure creatively introduces a classification behavior information representation, so that the determination of the information representation of the user and the interest of the user is more accurate and is closer to an actual situation of the user.

The classification behavior information representation of the user represents a classification behavior of the user, and may be formed according to historical behavior data of the user. The historical behavior data of the user may be a historical record of an application or a website (for example, an operation log record or a user access record of an application or a website) or a part of a historical record of an application or a website. The historical record of the application or the website records an interaction behavior of an entity such a user or an item, may not only include historical behavior data of a target user, but also include historical behavior data of other users, and may not only include a historical behavior of the user for an item, but also include a historical behavior between users and/or an interconnection between items. Classification behaviors performed by the user and items used as objects of the classification behaviors may be determined according to the historical behavior data of the user. The following describes how to generate an information representation of the classification behavior by using an example in which a classification behavior vector sequence is used as the classification behavior information representation.

It may be found, according to the historical behavior data, that each type of classification behavior may occur more than once for one or more objects. Each occurrence of the classification behavior may be represented by a vector, and a classification behavior vector sequence of a classification behavior obtained from the historical behavior data is formed by arranging a plurality of vectors corresponding to a plurality of occurrences of the classification behavior in order of occurrence time. In some examples, a vector representation of an object (that is, an item) targeted by each behavior may be directly used as a vector representation of the behavior. Therefore, a classification behavior vector sequence of each classification behavior of a user may include a vector sequence formed by arranging a vector representation of an item used as a classification behavior object in chronological order of occurrence of the classification behavior.

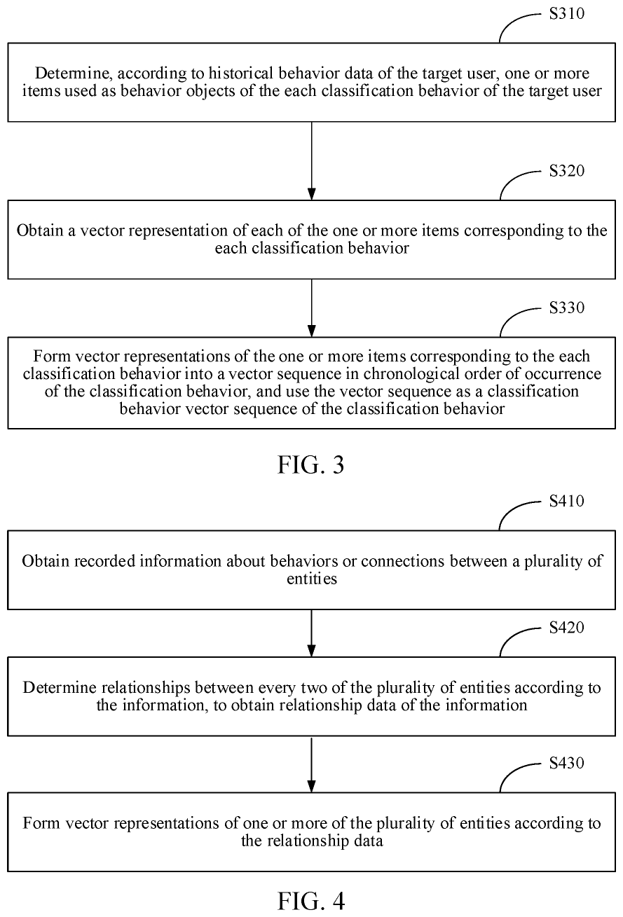

FIG. 3 shows an example of how to obtain a classification behavior vector sequence of each classification behavior of a target user (that is, step S210). In the embodiment shown in FIG. 3, step S210 may include the following steps.

S310. Determine, according to historical behavior data of the target user, one or more items used as a behavior object of the each classification behavior of the target user.

In step S310, an item corresponding to an object targeted by each occurrence of the each classification behavior of the target user may be determined by analyzing the historical behavior data of the target user.

S320. Obtain a vector representation of each of the one or more items corresponding to the each classification behavior.

Information about each item may be represented by a vector. There are various methods for vectorizing item information. For example, a category, an attribute, or a tag of an item may be determined according to description/content of the item, and then a word vector of the category, the attribute, or the tag of the item is used to represent the item. In step S320, the vector representation of the each item may be directly received from another place, or may be generated in step S320.

In one or more embodiments of the present disclosure, a new item information vectorization method applicable to the technical solution of the present disclosure is provided, and the method is described in detail by using an example in step S220.

S330. Form vector representations of the one or more items corresponding to the each classification behavior into a vector sequence in chronological order of occurrence of the classification behavior, and use the vector sequence as a classification behavior vector sequence of the classification behavior.

Each classification behavior of the user may be represented by a vector sequence, each vector in the vector sequence represents each occurrence of the classification behavior, and a vector corresponding to the each occurrence of the classification behavior is arranged in order of occurrence time, to form a classification behavior vector sequence of the classification behavior. In step S330, in an example, a vector representation of an item targeted by each occurrence of a classification behavior is used as a vector representation of the occurrence of the classification behavior. Therefore, the classification behavior vector sequence of each classification behavior determined according to the historical behavior data of the target user is formed by arranging vector representations of all historical objects of the classification behavior in chronological order of occurrence of the classification behavior.

Referring to FIG. 2, the exemplary method enters step S220.

S220. Obtain an information representation of a candidate item.

The “candidate item” refers to an item for which interest of the user is to be examined. The following describes how to obtain an information representation of an item by using an example in which a vector representation of the item is used as the information representation of the item.

Similar to the classification behavior vector sequence, the vector representation of the candidate item may be directly received from another place, or may be generated in step S220. As described above, item information is vectorized in various manners. In the embodiments of the present disclosure, a new method for determining a vector representation of an item according to historical behavior data is provided, where not only semantics of the item is considered, but also relationship data (that is, relationship data of interaction between a plurality of users and a plurality of items) included in the historical behavior data is considered. FIG. 4 shows an embodiment of the method, and the method embodiment is an information vectorization method, not only applicable to the vector representation of the item, but also applicable to a vector representation of another entity such as a user (however, in the technical solution for determining interest of the user in the present disclosure, the method is not used for the vector representation of the user). As shown in FIG. 4, the exemplary information vectorization method includes the following steps.

S410. Obtain recorded information about behaviors or connections between a plurality of entities.

The recorded information about the behaviors or connections between the plurality of entities may include inter-entity relationship data extracted from raw data. For example, the raw data may be a historical behavior data record of an application or a website, and the historical behavior data record may be any historical data reflecting an interaction behavior of an entity such as a user or an item, for example, an operation log record or a user access record of the application or the website.

The recorded information about the behaviors or connections between the plurality of entities may be obtained through step S410, including for example, recorded information about a behavior that a microblog user follows another microblog blogger, recorded information that a blogger posts a microblog belonging to a topic, recorded information that a microblog user likes a microblog belonging to a topic, and recorded information that a microblog belongs to a topic. In another example, in the case of a news website or a news application, information about a behavior that a news user follows another news user, information that the news user posts a piece of news belonging to a topic, information that the news user comments on a piece of news belonging to the topic, information that a piece of news belongs to a topic, and the like may be recorded. A relationship between entities (for example, microblog user/news user, another news user/blogger, news/microblog, and topic) may be conveniently obtained from these pieces of recorded information.

Now referring to FIG. 4, after obtaining the recorded information about behaviors or connections between the plurality of entities in step S410, the exemplary method enters step S420.

S420. Determine relationship data of the information according to the information.

The information records a behavior or connection between entities, and a relationship between the entities may be obtained by analyzing the information. Each data record included in the information may be retrieved through a related field name, to obtain entities involved in the data record. For example, the field names such as “user ID” and “item/content ID” may be retrieved, and values corresponding to the field names are recognized as entities. In another example, each data record included in the information includes information about a predetermined type in a predetermined location in the record, for example, “ID of a behavior initiator” is recorded with the first 32 bytes of the each data record. In this case, entities involved in the data record may be recognized by obtaining byte content in the predetermined location.

After the entities involved in the data record are recognized, the data record may be further analyzed to determine a relationship between the recognized entities. In an example, determining a relationship between entities may include determining whether the recognized entities have a relationship. In another example, determining a relationship between entities may further include determining an attribute of the relationship, for example, a type, a direction, or strength of the relationship.

Generally, a data record included in information includes both parties of a behavior or a connection, a type of the behavior or the connection, and an occurrence time/duration of the behavior. In the embodiments of the present disclosure, if a behavior or a connection is found by analyzing a data record, it is determined that there is a relationship between two entities involved as parties of the behavior or between the connection. For example, if a data record includes “information that a news user A comments on news C belonging a topic B”, a relationship R1 may be determined based on the comment behavior in the record indicting that there is a relationship between the news user A and the news C, and a relationship R2 may be further determined based on the connection “news C belonging to a topic B”, indicating that there is a relationship between the topic B and the news C.

In another example, a direction of the relationship may be further determined. For example, it may be determined, according to the comment behavior, that a direction of the relationship R1 is from the news user A to the news C, and a type of the relationship is “comment”. It may be further determined, according to the connection “news C belonging to a topic B”, that a direction of the relationship R2 is from the news C to the topic B.

In some embodiments, besides determining that there is a relationship between the two entities corresponding to a behavior or a connection, a weight value of the relationship may be further determined. A weight value of a relationship may represent strength of the relationship. In an embodiment, for a relationship associated with a behavior, a corresponding weight value may be determined by analyzing one or more of a behavior type, a behavior duration, and a behavior frequency of the behavior. In an example, one of the behavior type, the behavior duration, and the behavior frequency may be used separately as alternatives to determine a weight value. For example, it may be set that different behavior types correspond to different weight values (for example, it may be set that a browse behavior corresponds to a weight value of 1/3 and a click behavior corresponds to a weight value of 2/3). Alternatively, different behavior durations may correspond to different weight values (for example, it may be set that a weight value is 1/10 when a duration is below 1 minute, a weight value is 2/5 when a duration is between 1 minute and 3 minutes, and a weight value is 1/2 when a duration is above 3 minutes). Alternatively. different behavior frequencies may correspond to different weight values (for example, it may be set that a weight value is 1/10 when a behavior frequency is below 1 time/month, a weight value is 1/5 when a behavior frequency is between 1 and 5 times/month, a weight value is 3/10 when a behavior frequency is between 5 and 10 times/month, and a weight value is 1/2 when a behavior frequency is above 10 times/month). In another alternative embodiment, a weight value may be determined by using a combination of two or more of the behavior type, the behavior duration, and the behavior frequency. For example, independent weight values respectively obtained according to two or more of the behavior type, the behavior duration, and the behavior frequency may be calculated, and then a weighted sum of the obtained independent weight values may be used as a final weight value. When the behavior frequency is calculated, two instances with the same behavior type and same direction that occur between two parties but at different times are considered as the same behavior occurring twice.

For a relationship caused by a connection, a weight value of the relationship may be set to a predetermined value, for example, 1.

The foregoing embodiments describe how to determine a relationship between every two entities. In another embodiment, besides determining the relationship between every two entities as relationship data of the information according to the data record in the information, the method may further include the following steps: determining an attribute feature of each of the plurality of entities; and determining that there is a relationship between the each entity and each attribute feature of the entity, further determining that entities having one or more same features are related, and adding the relationship to the relationship data of the information. For example, for an entity “news C” recognized from information, values of attribute features “tag” and “category” of the entity may be determined according to content of the news. For example, it may be determined that the tag is “Taiwan Strait” and the category is “current politics”. Entities having one or more attribute features that are the same may be found by determining attribute features of entities and comparing the attribute features therebetween, and such two entities may be considered as having an indirect relationship through the same attribute feature.

Through the foregoing processing, the relationship between every two entities involved in the information may be determined. The determined relationships may be recorded for subsequent use.

A relationship between entities may be recorded as data in a plurality of forms, for example, may be recorded as a list of each relationship between entities (herein refers to a direct relationship between two entities), or may be recorded as a form of structured data. As an example, it is assumed that the following relationships are determined:

there is a relationship between a user A and a topic F, a relationship type is follow, and a weight value is ω₁;

there is a relationship between the user A and news C, a relationship type is comment, and a weight value is ω₂;

there is a relationship between the user A and a user E, a relationship type is follow, and a weight value is ω₃;

there is a relationship between the user E and the news C, a relationship type is post news, and a weight value is ω₄;

there is a relationship between the news C and a topic B, a relationship type is belong, and a weight value is ω₅;

there is a relationship between news D and the topic B, a relationship type is belong, and a weight value is ω₆;

there is a relationship between an attribute feature cut1 and the news C, a relationship type is belong, and a weight value is ω₇;

there is a relationship between an attribute feature tag1 and the news C, a relationship type is belong, and a weight value is ω₈;

there is a relationship between an attribute feature cat1 and the news C, a relationship type is belong, and a weight value is ω₉;

there is a relationship between an attribute feature cat2 and the user A, a relationship type is belong, and a weight value is ω₁₀; and

there is a relationship between an attribute feature tag2 and the user A, a relationship type is belong, and a weight value is ω₁₁.

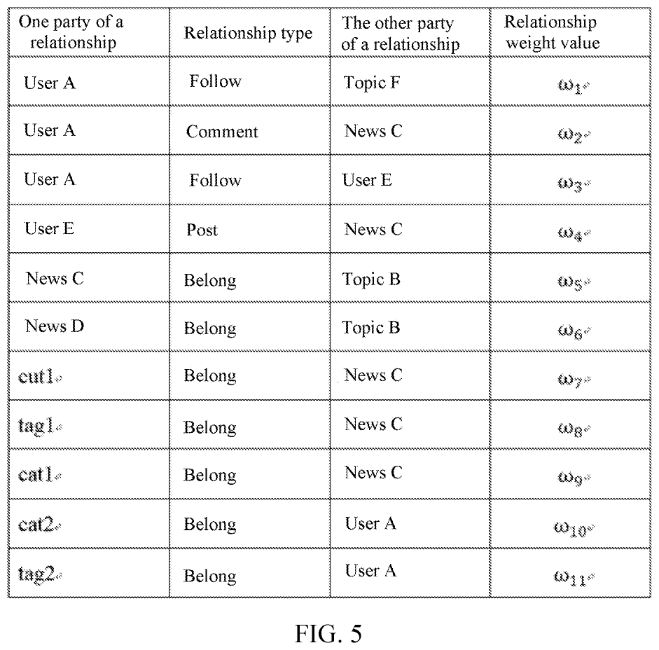

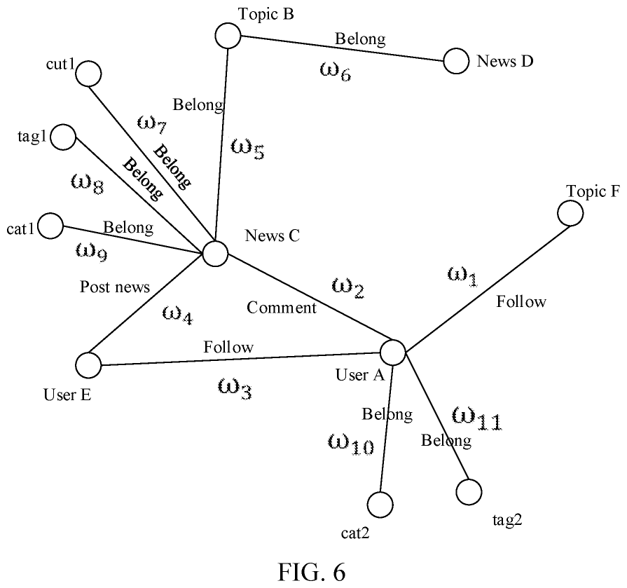

In an example, as shown in FIG. 5, the foregoing relationships may be recorded in the form of a relationship list. In another example, as shown in FIG. 6, the foregoing relationships may be recorded in the form of structured data such as an interactive map. In FIG. 5, each relationship between every two entities and attributes (a type and a weight value) of the relationship are listed one by one in a list manner. In the interactive map in FIG. 6, each entity is represented as a node in the interactive map, and a relationship between two entities is represented by using a connecting line between two corresponding nodes. In an example, one or more connecting line attributes such as a weight value of a connecting line (a weight value of a relationship), a type of a connecting line (relationship/behavior type), and a direction of a connecting line (a direction of a relationship) may also be marked on a corresponding connecting line in the interactive map. Such interactive map may be stored in the form of a graphical database or knowledge graph. The nodes and connecting lines correspond to entities and edges in the graphical database or knowledge graph.

It can be seen from FIG. 6 that:

the example entity types include: news, a user, and a topic, the user belongs to a user entity, and the news and the topic belong to an item entity;

the example relationship types include: (1) an entity-attribute relationship: a belonging relationship; (2) a relationship between entities: news and a topic (many-to-many), a user and news (one-to-many and many-to-many; an example interaction relationship includes: comment, click, repost, and browse), a user and a user (many-to-many; follow, and being followed), and a user and a topic (many-to-many; follow, and being followed); and

the example attribute features include: for news, including a content excerpt, a tag, and a category (cat); for a user, including a tag and a cat; and for a topic, including a content excerpt, a tag, and a cat.

It may be understood from comparison between FIG. 5 and FIG. 6 that, although a direct relationship between entities may be conveniently seen from both the table in FIG. 5 and the interactive map in FIG. 6, an indirect relationship between the entities may not be conveniently seen from FIG. 5, and two relationships sharing one behavior/connection can be connected only through search to form the indirect relationship, while in FIG. 6, a path of the indirect relationship between the entities may be intuitively seen. Therefore, it may be understood that by recording the relationship data in the form of an interactive map, all direct and indirect relationships between entities may be conveniently and intuitively learned, thereby facilitating reference, analyzing, search, and other uses of the relationship data. Especially, in a case of massive relationship data, the relationship data in the form of the relationship list may be very inconvenient to use, but a structured form such as the interactive map may intuitively and clearly reflect complex relationships.

The interactive map may be represented by using the following formula:

G=(V,E,φ),

where a node set of the interactive map V=U∪Mc∩Uf∩T∩C∩Tag; a connecting line set of the interactive map E={(e₁,ωₑ_{ᵢ})|ωₑ_{ᵢ}∈Ω}; and an association mapping between a connecting line and a node in the interactive map φ:E→V×V. The interactive map in FIG. 6 is used as an example, a first user set U={u₁, u₂, . . . u|U|}, a news set Mc={mc₁, mc₂, . . . , mc_{|Mc|}}, a second user set Ug={uf₁, uf₂, . . . , uf_{|Uf|}}, a topic set T={t₁, t₂, . . . , t_{|T|}}, a content excerpt set W={w₁, w₂, . . . , w_{|W|}}, a category set C={c₁, c₂, . . . , c_{|C|}}, a tag set Tag={tag₁, tag₂, . . . , tag_{|Tag|}}, and a weight set Ω={w₁, w₂, . . . , w_{|Ω|}}.

A communicating node sequence a v₁e₁v₂e₂ . . . eₚ₋₁vₚ,vᵢ≠vⱼ,vᵢ,vⱼ∈V in the interactive map is referred to as a path from a node v₁ to a node vₚ in the map, recorded as p(v₁,vₚ), a length of the path is |p(v₁,vₚ)|=p−1, a weighted length of the path is |p(v₁,vₚ)|_{w}=Π_{w1}(v₁_{_{v p}}₎wₑ_{ᵢ}, a set of all paths between two nodes is recorded as P(v₁,vₚ) and a measure of two nodes on the interactive map is

$$ρ ( {v}_{s} , {v}_{f} ) = {max}_{p ( {v}_{z} , {v}_{a} ) ∈ P ( {v}_{z} , {v}_{a} )} {\vert p ( {v}_{z} , {v}_{f} ) \vert}_{ω} .$$

The method for determining a relationship between entities from information and displaying the relationship as an interactive map is very suitable for processing massive historical behavior data of a user, and a relationship between entities may be conveniently and intuitively displayed in a structured form.

Referring to FIG. 4, after the relationship data of the information is obtained in step S420, the relationship data (which may be in the form of the relationship list, or may be the structured relationship data such as the interactive map) may be used in a vector representation process of an entity (for example, a user and an item) in step S430.

S430. Form vector representations of one or more of the plurality of entities according to the relationship data.

When vectorization is performed on entity information, a semantic representation or a classification category representation manner may be used. In this embodiment, a new information vectorization method is provided, that is, a vector representation of an entity is performed according to relationship data determined from massive historical behavior data of a user.

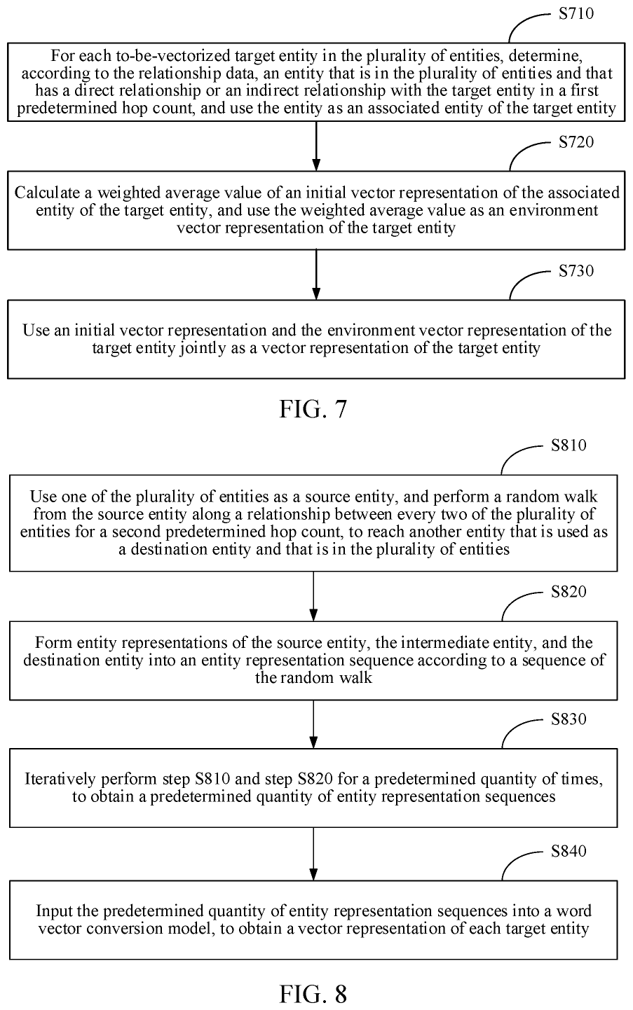

The following describes an example of a specific implementation of step S430 separately by using two embodiments with reference to FIG. 7 and FIG. 8.

In the embodiment of FIG. 7, an associated entity of a to-be-vectorized target entity is determined according to the relationship data, and an environment vector representation of the target entity is determined according to the associated entity and used as a part of the entity vector representation. As shown in FIG. 7, in this embodiment, step S430 may include the following steps.

S710. For each to-be-vectorized target entity in the plurality of entities, determine, according to the relationship data, an entity that is in the plurality of entities and that has a direct relationship or an indirect relationship with the target entity in a first predetermined hop count, and use the entity as an associated entity of the target entity.

For a to-be-vectorized target entity, in step S710, an associated entity of the target entity may be determined according to inter-entity relationship data. The associated entity may generally refer to an entity having a direct relationship or an indirect relationship with the target entity. The indirect relationship means that: two entities indirectly have a relationship through an intermediate entity, that is, one of two entities has a direct relationship with one intermediate entity, and the intermediate entity has a direct relationship with the other of the two entities; or the two entities indirectly have a relationship through a plurality of intermediate entities, that is, one of two entities has a direct relationship with the first intermediate entity, the subsequent intermediate entities have a direct relationship with each other until the last intermediate entity, and the last intermediate entity has a direct relationship with the other of the two entities. In the interactive map, an indirect relationship between two entities is reflected as: a path that is formed by connecting lines between nodes and that is between the two entities.

In the embodiment of FIG. 7, not all associated entities of the target entity need to be determined, but only an associated entity of which a hop count from the target entity is less than or equal to the first predetermined hop count is determined, to be used for calculating an environment vector representation of the target entity.

The hop count refers to a quantity of relationships passing from one entity in the plurality of entities to another entity having a direct relationship or an indirect relationship with the entity along relationships between every two of the plurality of entities. In the interactive map, a hop count between two entities is reflected as: a quantity of connecting lines included in a path between nodes corresponding to the two entities.

The first predetermined hop count may be set to an integer value greater than or equal to 1. For example, when the first predetermined hop count is set to 1, only an entity that has a direct relationship with the target entity is determined as the associated entity. In an embodiment, the first predetermined hop count is set to 2, that is, an entity having a direct relationship with the target entity and an entity having an indirect relationship with the target entity through an intermediate entity are determined as associated entities.

In some cases, there may be a plurality of paths between two entities/nodes, resulting in that hop counts between the two entities/nodes along different paths are different. In this case, provided that the smallest hop count is less than or equal to the first predetermined hop count, it is considered that a condition of the associated entity in step S710 is satisfied.

An example of the relationship data shown in FIG. 5 and FIG. 6 is used. Assuming that the target entity is news C, and the first predetermined hop count is 2, it may be determined from FIG. 5 and FIG. 6 that entities having a direct relationship or an indirect relationship with the news C in 2 hops include: a user A, a user E, a topic B, a topic F, and news D. The user A, the user E, and the topic B are one hop apart from news C (that is, in a direct relationship), and the topic F, and the news D are two hops apart from the news C (that is, in an indirect relationship with one intermediate entity). Therefore, it may be determined that entities, namely, the user A, the user E, the topic B, the topic F, and the news D are the associated entities of the news C.

It may be learned, by comparing processes of determining an associated entity from FIG. 5 and FIG. 6, that the associated entity having a direct relationship or an indirect relationship with the news C at and within two hops may be very conveniently and intuitively determined from FIG. 6. The reason is that, by taking only one hop or two hops along a path formed by a connecting line starting from the news C, a destination entity may be determined as the associated entity. However, in the relationship list of FIG. 5, only the entities, namely, the user A, the user E, and the topic B having a direct relationship with the news C can be intuitively seen, and then the topic F and the news D are obtained by separately searching for entities having a direct relationship with the user A, the user E, and the topic B, resulting in that neither the topic F nor the news D can be intuitively determined, and a speed of determining an associated entity is obviously low. When the relationship data comes from massive information and is large and complex, the advantages of structured data such as the interactive map (or knowledge graph) are more advantageous, and a speed of processing interactive map data is higher than that of processing relationship list data.

In the foregoing examples, all entities having a direct relationship or an indirect relationship with a target entity in the first predetermined hop count are used as associated entities. In another example, entities in relationship data are divided into a user entity (for example, a user) and an item entity (for example, news and a topic). When a target entity (regardless of whether the target entity is a user entity or an item entity) is determined, an item entity having a direct relationship or an indirect relationship with the target entity in the first predetermined hop count is used as an associated entity of the target entity, and a user entity having a direct relationship or an indirect relationship with the target entity in the first predetermined hop count is removed.

After the associated entity of the target entity is determined, a process of the exemplary information vectorization method enters step S720.

S720. Calculate a weighted average value of an initial vector representation W₁ of the associated entity of the target entity, and use the weighted average value as an environment vector representation of the target entity.

Herein, the initial vector representation of each entity is a vector representation of the each entity without considering an associated entity determined according to relationship data. The initial vector representation may be any vector representation of the entity, for example, may be an initial semantic vector representation.

In step S720, the environment vector representation of the target entity is generated by using the associated entity obtained through the relationship data. Specifically, the weighted average value may be calculated for the obtained initial vector representations of the associated entities, and used as the environment vector representation of the target entity. When the weighted average value is calculated, a weight coefficient of the initial vector representation of each associated entity may be determined according to experience, a statistical result, experiment, or the like, and the weight coefficient is to reflect strength of a relationship between the corresponding associated entity and the target entity, thereby reflecting a proportion of an initial vector representation of the corresponding associated entity in calculating an environment vector representation of the target entity.

As described above, an initial vector representation of each entity may be one of a plurality of vector representation manners. For example, the initial vector representation of the each entity may be determined through a semantic representation, and the initial vector representation of the semantic representation of the each entity is referred to as a basic semantic vector representation. There may be a plurality of basic semantic vector representations of an entity. In an example, word vectors of one or more of attribute features such as content, category, and tag of an entity may be used as the basic semantic vector representations of the entity. For example, the word vectors of the attribute features may be added, concatenated, or combined in another manner to form the basic semantic vector representation.

Therefore, for each associated entity, attribute features of the associated entity need to be determined first. There are a plurality of manners of determining attribute features of an entity. For example, an attribute feature such as a content excerpt, a tag, or a category of the entity may be obtained by analyzing content or behavior data of the entity, and then word vector conversion is performed on the attribute feature (for example, conversion is performed by using a word2vec model), to obtain a semantic vector representation of the attribute feature. Alternatively, an analyzed attribute feature of an entity is received from another device or module (for example, a user center), and then word vector conversion is performed. For example, for an associated entity of news C, namely news D, assuming that it may be determined, by analyzing content of the news D, that attribute features of the news D are: n content excerpts of which corresponding word vectors are w₁^{mc}, w₂^{mc}, . . . , wₙ^{mc}; m tags of which corresponding word vectors are tag₁^{mc}, tag₂^{mc}, . . . , tagₘ^{mc}; and one category of which corresponding word vectors are c₁^{mc}, c₂^{mc}, . . . cₗ^{mc}.

Then, vector concatenation is performed on semantic vector representations of all attribute features of the associated entity, and the concatenated semantic vector representation is used as a basic semantic vector representation of the associated entity. As described above, word vectors of attribute features of an entity may be added, concatenated, or combined in another manner to form a basic semantic vector representation of the entity. In this embodiment, the basic semantic vector representation is formed through vector concatenation, that is, vector concatenation is performed on semantic vector representations of all attribute features of each associated entity, to obtain a basic semantic vector representation of the associated entity. For example, an obtained basic semantic vector representation of the news D may be:

W_{b}(mc)=[w₁^{mc}w₂^{mc}. . . wₙ^{mc}tag₁^{mc}tag₂^{mc}. . . tagₘ^{mc}c₁^{mc}c₂^{mc}. . . cₗ^{mc}].

Similarly, a basic semantic vector representation of each of other associated entities may be determined according to the foregoing processing.

As described above, there are various determining manners of a weight coefficient αᵢ of an initial vector representation of each associated entity. In this embodiment,

$$\frac{{ρ}_{i}}{{λ}_{i}}$$

is used as a weight coefficient of each associated entity, that is,

$${α}_{i} = \frac{{ρ}_{i}}{{λ}_{i}} ,$$

where ρᵢ is a product of weight values of one or more relationships passing from the target entity to the associated entity, and λᵢ is a count of hops passing from the target entity to the associated entity.

As described above, there may be a plurality of paths between a target entity and an associated entity of the target entity. When there are a plurality of paths from the target entity to the associated entity, products of weight values of relationships (a connecting line between two nodes on the interactive map) that the paths pass through may be different, that is, ρᵢ and λᵢ of each path are different. In this case, a measure between a target entity and an associated entity on the interactive map is used as ρᵢ, that is, the largest product among products of weight values of one or more relationships passing from the target entity to the associated entity is selected. In addition, the smallest hop count between the target entity and the associated entity is used as λᵢ. Therefore, a weight coefficient of each associated entity may be calculated. Therefore, the weighted average value Wₑ may be calculated according to the following formula:

$${W}_{e} = \frac{{\sum }_{i = 1}^{N} {α}_{i} \cdot {W}_{i}}{N} ,$$

where N is a quantity of associated entities of the target entity. That is, a weighted average is calculated for initial vector representations Wᵢ of the associated entities. Specifically, the initial vector representations Wᵢ of the associated entities are multiplied by respective weight coefficients αᵢ, products are summed, and then a sum is divided by the quantity N of associated entities, to obtain an environment vector representation Wₑ of the target entity.

It can be understood from the process of determining the initial vector representation that dimensions of initial vector representations of associated entities may be different. When a weighted sum of initial vector representations of associated entities is calculated, a maximum dimension in the initial vector representations may be used as a dimension of the weighted average value Wₑ. For a vector of which a dimension is insufficient in the initial vector representations, the dimension of the vector is enabled to reach the maximum dimension through zero-filling or zero padding.

In the foregoing embodiments, the initial vector representation (basic semantic vector representation) of the each associated entity is determined in a semantic representation manner and the environment vector representation (semantic environment vector representation) of the target entity is obtained. However, it is to be understood that the initial vector representation of the each associated entity may alternatively be determined in another representation manner, and therefore the environment vector representation of the target entity in the same representation manner is obtained.

The environment vector representation of the target entity may be determined according to the associated entity through step S720. Then, step S730 is performed.

S730. Use an initial vector representation and the environment vector representation of the target entity jointly as a vector representation of the target entity.

In step S730, the environment vector representation obtained in step S720 is used as a part of the vector representation of the target entity. Using an initial vector representation and the environment vector representation jointly as a vector representation of the target entity refers to using a combination of the initial vector representation of the target entity and the environment vector representation of the target entity. There may be various types of combination manners. In an example, an initial vector representation of a target entity and an environment vector representation of the target entity are added in the vector space as a vector representation of the target entity. In another example, a vector is formed by an initial vector representation of a target entity and an environment vector representation of the target entity through vector concatenation, and used as a vector representation of the target entity. In still another example, an initial vector representation of a target entity and an environment vector representation of the target entity are used as independent vectors, to form a vector set as a vector representation of the target entity.

The embodiment of FIG. 7 describes that the relationship data is reflected in the vector representation of the target entity in a manner of determining the associated entity of the target entity and then determining the environment vector representation of the target entity according to the associated entity. FIG. 8 shows another implementation of representing relationship data in a vector representation of a target entity, that is, another example of a specific implementation of step S430. In this implementation, a predetermined quantity of entity representation sequences are obtained by performing a plurality of random walks along a relationship between every two entities by using a random walk algorithm, and a vector representation of each target entity is obtained by using a word vector conversion model. As shown in FIG. 8, the example of a specific implementation of step S430 may include the following steps.

S810. Use one of the plurality of entities as a source entity, and perform random walks from the source entity along a relationship between every two of the plurality of entities for a second predetermined hop count, to reach another entity that is used as a destination entity and that is among the plurality of entities, an entity that is located between the source entity and the destination entity and through which the random walk passes being used as an intermediate entity.

Herein, the plurality of entities refer to a plurality of entities included in the relationship data described above. In step S810, the random walk is performed according to a random walk algorithm based on relationship data along a relationship (reflected as a connecting line between nodes on the interactive map) between entities for the second predetermined hop count. Such a random walk passes through a plurality of entities/nodes, and a sequence of entities/nodes through which the random walk passes may be obtained according to a sequence of the random walk.

The hop count refers to a quantity of relationships passing from one entity in the plurality of entities to another entity having a direct relationship or an indirect relationship with the entity between every two of the plurality of entities, and is represented by a quantity of connecting lines between nodes included in a path from one entity to another entity on the interactive map. The second predetermined hop count means that during the random walks, a source entity (corresponding to a source node on the interactive map) needs to reach a destination entity (corresponding to a destination node on the interactive map) after passing through the second predetermined hop count of intermediate nodes. The value of the second predetermined hop count may be determined according to experience, a statistical result, an experimental result, or the like. For example, the second predetermined hop count may be set to 20.

The “random walk algorithm” herein means that selection of a source entity/source node, an intermediate entity/intermediate node, and a destination entity/destination node is controlled, so that a path with a predetermined hop count is formed along relationship data in a random manner, to determine a plurality of entities/nodes (the source entity/source node, the intermediate entity/intermediate node, and the destination entity/destination node) arranged in a sequential order of walk.

S820. Form entity representations of the source entity, the intermediate entity, and the destination entity into an entity representation sequence according to a sequence of the random walk.

In step S820, entity representations of the entities/nodes (including the source entity/source node, the intermediate entity/intermediate node, and the destination entity/destination node) through which the random walk passes in step S810 are formed into an entity representation sequence according to the sequence of the random walk.

The “entity representation” herein refers to a representation of an entity, which may be an identifier (ID) of an entity, or may be another character string that may identify an entity.

S830. Iteratively perform step S810 and step S820 for a predetermined quantity of times, to obtain a predetermined quantity of entity representation sequences.

In step S830, step S810 and step S820 are performed in a cyclic manner for a plurality of iterations, to obtain a plurality of different entity representation sequences. A source entity, an intermediate entity, and a destination entity through which a random walk passes in each cycle are selected, so that the predetermined quantity of obtained entity representation sequences are different, and the predetermined quantity of entity representation sequences include entity representations of all to-be-vectorized target entities. The meaning of obtaining a plurality of entity representation sequences through a plurality of cycles is in that: (1) a plurality of finally obtained entity representation sequences include entity representations of all to-be-vectorized target entities, and only in this way, a vector representation of each target entity can be obtained in step S840; and (2) a relationship reflected by relationship data is completely reflected in a sequence of entities of the entity representation sequence to the maximum extent, a part of the relationship data is intercepted through each random walk, and diversity of reflection of the relationship data in the entity representation sequence is increased by concatenating a plurality of parts.

A quantity of iterations of cycles is equal to a quantity of obtained entity representation sequences. A predetermined quantity of iterations of cycles may be determined according to experience, a statistical result, an experimental result, or the like. In an example, in a case that a processing time and a processing speed are balanced, a predetermined quantity of iterations that a cycle needs to reach is set as large as possible, to vectorize information by using the relationship data in a more systematic manner.

S840. Input the predetermined quantity of entity representation sequences into a word vector conversion model, to obtain a vector representation of each target entity.

There may be a plurality of manners of converting a plurality of entity representation sequences into vector representations of entities. In one manner, conversion is performed through the word vector conversion model, that is, the plurality of entity representation sequences obtained in step S830 are inputted into the word vector conversion model, and vector representations of all entities included in the entity representation sequences are outputted by the word vector conversion model. In an example, the word vector conversion model may be a word2vec model which outputs a word vector representation (embedding representation) of each entity according to the plurality of inputted entity representation sequences.

Although step S430 is implemented in the embodiments in FIG. 7 and FIG. 8 in different process steps, it aims at maximally and more completely extract relationship data, thereby improving accuracy of the vectors.

In an embodiment, after the vector representation of the target entity is obtained in step S730 or step S840, subsequent processing may be further included, so that the vector representation of the target entity is more accurate. For example, a vector space of a target entity may remain consistent through the subsequent processing, and information is more compact. For example, the subsequent processing may be performed through a neural network, so that a vector space of a target entity may remain consistent, and information is more compact. In this embodiment, after step S730 or step S840, the vector representation of each target entity is re-represented through a neural network. The “vector representation of the target entity” herein may refer to the vector representation of the target entity obtained in step S730, or may be the vector representation of the target entity obtained in step S840.

For the vector representation that is obtained in step S730 and that includes the initial vector representation and the environment vector representation, in an example, the initial vector representation and the environment vector representation are separately inputted into the neural network. In another example, a concatenated vector of the initial vector representation and the environment vector representation is inputted into the neural network, and which part of the concatenated vector is the initial vector representation and which part is the environment vector representation are indicated in an input parameter.

The neural network may be any neural network that may extract information from the inputted vector representation and re-represent the inputted vector. In an example, the neural network may include a convolutional neural network. In another example, the neural network may include a deep-leaning neural network.

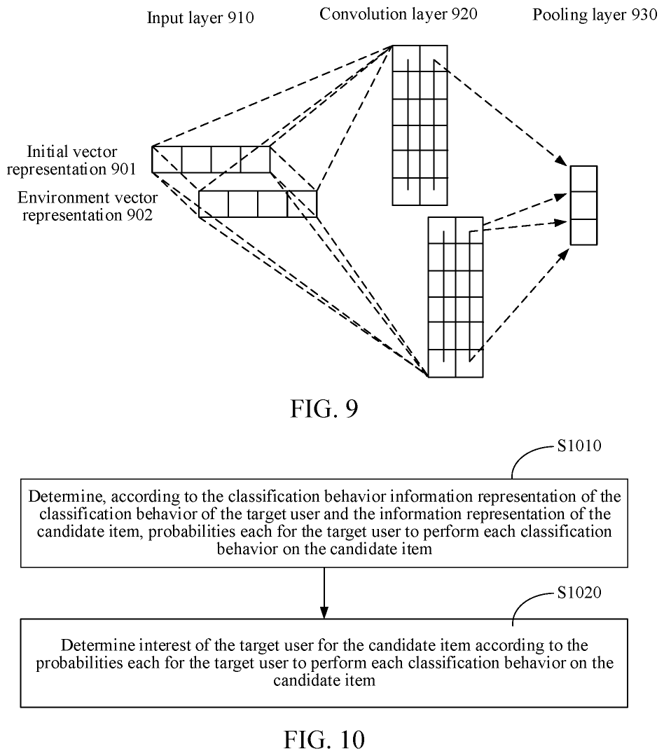

FIG. 9 is a schematic diagram of re-representing, by a neural network, an inputted entity vector representation according to an exemplary embodiment of the present disclosure. In this embodiment, the neural network includes a convolutional neural network, and the entity vector representation includes an initial vector representation and an environment vector representation.

As shown in FIG. 9, an input layer 910 of the convolutional neural network receives an initial vector representation 901 and an environment vector representation 902 that are inputted. In an example, when an entity vector representation is a concatenated vector of an initial vector representation and an environment vector representation, the input layer 910 splits an inputted vector representation into the initial vector representation 901 and the environment vector representation 902 according to an input parameter (that is, information indicating which part of the entity vector representation is the initial vector representation and which part is the environment vector representation). The outputs 901 and 902 of the input layer 910 are connected to convolution layers 920 that are placed in parallel and that have different sizes of convolution windows. After a convolution operation is performed in the convolution layers 920, outputs of the convolution layers 920 are connected to a pooling layer 930, and the pooling layer 930 compresses the outputs of the convolution layers 920 into a vector. The vector is a re-representation vector of the inputted entity vector representation, and the re-representation vector is used as a final vector representation of a target entity.

In an example, parameters of the neural network may be set and adjusted according to an experimental result, to obtain an optimal re-representation vector, and the parameters are, for example, a dimension of an outputted vector of the neural network, a size of each convolution window, and a quantity of convolution layers of the neural network.

The foregoing uses the convolutional neural network and the vector representation in step S730 as an example for description. It is to be understood that in a case of the deep neural network and/or the vector representation in step S840, the operation processing is similar to that in the foregoing descriptions. Details are not described herein again.

In the foregoing steps S410 to S430, S710 to S730, and S810 to S840, the method embodiment for vectorizing information about entities such as a user and an item is described. The method embodiment may be suitable for generating the information representation of the candidate item in step S220, or may be suitable for generating the vector representation of the item used as a classification behavior object in step S320. It is to be understood that the information representation of the candidate item and the vector representation of the item used as the classification behavior object may alternatively be formed by using another method.

In another example, the information representation of the candidate item in step S220 and the vector representation of the item used as the classification behavior object in step S320 are further improved compared with those in the foregoing information vectorization method embodiment, that is, for an item, a concatenated vector of a vector representation of the item obtained according to the foregoing information vectorization method embodiment and a vector representation of an entity to which the item belongs is used as a final vector representation of the item. In the example, for an item, assuming that a vector obtained according to the foregoing information vectorization method embodiment is represented as W1, and a vector of another entity having a belonging relationship with the item is represented as W2, a final vector of the item is represented as a concatenated vector of W1 and W2. For example, if a vector of news C is represented as W_{C} according to the foregoing information vectorization method embodiment, and a vector of a topic B to which the news C belongs is represented as W_{B}, a final vector of the news C may be represented as a concatenated vector of the vector W_{C} and the vector W_{B}.

Returning to step S220 in FIG. 2, although step S210 and step S220 shown in FIG. 2 have a sequential order, it is to be understood that there is no necessary execution order between the two steps, and the two steps may be interchangeable in an execution order, or may be performed simultaneously in parallel. Then, the exemplary method enters step S230.

S230. Determine interest of the target user for the candidate item according to the classification behavior information representation of the classification behavior of the target user and the information representation of the candidate item.

In step S230, besides considering the information representation of the candidate item (for example, the vector representation of the candidate item) obtained in step S220, it may be determined that the interest of the target user for the candidate item may be further based on the classification behavior information representation (for example, the classification behavior vector sequence) obtained in step S210, The interest so predicted may be closer to an actual interest of the target user. After step S230, an item may be further recommended to the target user according to the interest of the target user for the candidate item, thereby improving a recommendation success rate, avoiding recommendation iterations, and improving utilization of network resources. It may be learned from steps S410 to S430, S710 to S730, and S810 to S840 and according to the foregoing forming manner embodiment of the classification behavior vector sequence described in steps S310 to S330 that the classification behavior vector sequence may include the following information:

item feature information: the classification behavior vector sequence is formed by using a vector representation of an item used as a classification behavior object, and therefore, the item feature information is included;

behavior feature information of a target user: the vector representation of the item used as the classification behavior object is formed according to relationship data of the target user, and the relationship data includes more complete and systematic behavior feature information of the target user; and time sequence feature information: vectors of classification behavior objects are arranged in order of occurrence time, to form a time sequence, and therefore a time sequence feature is included.

In the embodiments of step S230, one or more of the three features are integrally used when the interest of the target user is determined.

There are various specific implementations for determining the interest according to the classification behavior information representation and the information representation of the candidate item. For example, a similarity between the classification behavior information representation and the information representation of the candidate item may be calculated, and the similarity is used for representing the interest. In another example, the interest may be predicted by using a machine learning model.

FIG. 10 shows an example of a specific implementation of determining interest according to a classification behavior information representation and an information representation of a candidate item (that is, step S230). In the example, classification behavior probabilities corresponding to each of behavior classification of a plurality of behavior classifications of the target user is determined first according to the classification behavior information representation and the information representation of the candidate item, and then the interest is determined according to each classification behavior probability. As shown in FIG. 10, in the example, step S230 may include the following steps.

S1010. Determine, according to the classification behavior information representation of the classification behavior of the target user and the information representation of the candidate item, probabilities teach for the target user to perform behavior of each behavior classification on the candidate item.

In this example, the interest is not directly determined, but the classification behavior probabilities corresponding to behavior classifications of the target user are first determined in step S1010. For example, if classification behaviors of a target user include: click, like, comment, and repost, a probability that the target user clicks a candidate item, a probability that the target user likes the candidate item, a probability that the target user comments on the candidate item, and a probability that the target user reposts the candidate item are determined in step S1010.

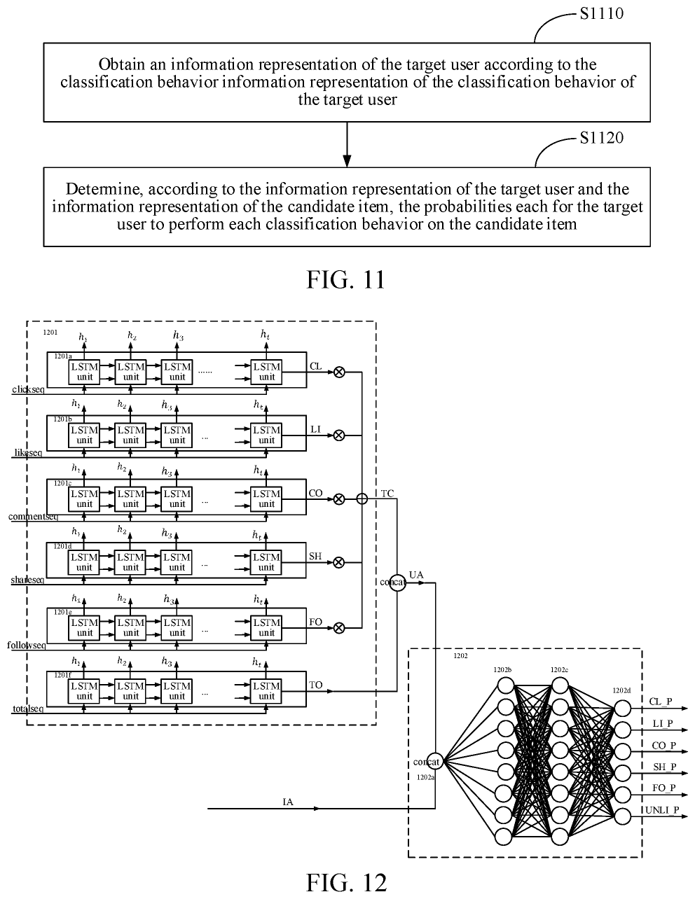

FIG. 11 shows an example of an implementation of how to determine each classification behavior probability (that is, step S1010). As shown in the example of FIG. 11, step S1010 may include the following steps.

S1110. Obtain an information representation of the target user according to the classification behavior information representation of the classification behavior of the target user.

In this example, an information representation of a target user is first determined according to a classification behavior information representation of the target user. As described above, user information may also be vectorized by using the foregoing information vectorization method embodiment. However, in the embodiments of the present disclosure, the information representation of the target user is determined according to the classification behavior information representation, for example, the vector representation of the target user is determined according to the classification behavior vector sequence. One or more vector sequences (classification behavior vector sequences) may be re-represented as one vector (a vector representation of the target user) through various types of vector conversion and operations. Further, referring to FIG. 12, which describe in more detail how to determine the vector representation of the target user according to the classification behavior vector sequence.

S1120. Determine, according to the information representation of the target user and the information representation of the candidate item, the corresponding probabilities each for the target user to perform behavior of each behavior classification on the candidate item.

The classification behavior probabilities may be determined according to the information representation of the target user and the information representation of the candidate item in a plurality of manners such as similarity calculation and machine learning.

In an example, if an information representation of a target user is a vector representation of the target user, and an information representation of a candidate item is a vector representation of the candidate item, the information representation of the target user in step S1110 may include a vector representation of the target user. Calculation of the vector representation of the target user in step S1110 and calculation of the classification behavior probabilities in step S1120 may be implemented through a machine learning model. Specifically, a classification behavior vector sequence of classification behaviors of a target user and a vector representation of a candidate item are used as an input to a classification behavior probability prediction model, and the corresponding probability is obtained through the model. The classification behavior probability prediction model may be obtained by training a machine learning algorithm by using a large amount of historical data (for example, a large amount of historical behavior data of a user). Specifically, a classification behavior vector sequence of a user and a vector representation of an item used as a classification behavior object of the user may be extracted from the large amount of historical behavior data of the user, and inputted into a machine learning model, so that a classification behavior probabilities outputted by the model are as close as possible to a classification behavior probability of actual occurrence specified in the historical behavior data by adjusting model parameters.

An appropriate model parameter may be determined through training by using a large amount of historical behavior data of a user, so that a relatively precise classification behavior probability prediction may be outputted for any inputted classification behavior vector sequence and vector representation of a candidate item.

In an example, training of the machine learning model and prediction of the classification behavior probability may be implemented through a neural network. A classification behavior vector sequence of a user and a vector representation of an item used as a classification behavior object of the user that are extracted from a large amount of historical behavior data of the user may be inputted into the neural network, so that a classification behavior probabilities outputted by the neural network are as close as possible to a classification behavior probability of actual occurrence specified in the historical behavior data. When the neural network is trained, a loss function may be determined according to a deviation between a corresponding probabilities outputted by the neural network and true probabilities specified in the historical behavior data, and the determined loss function is fed back to the neural network (for example, by using a back propagation algorithm), to adjust a parameter of the neural network, so that probabilities outputted by the neural network are close to an actual probability, thereby generating an appropriate neural network parameter through training. In an example, a loss function Loss(θ) may be determined by using the following formula:

$$Loss ( θ ) = {\sum }_{k = 1}^{n} CE ( {θ}^{K} ) + {c}_{1} \cdot {R}_{1} ( θ ) + {c}_{2} \cdot {R}_{2} ( θ ) ,$$

where n is a quantity of input samples (that is, a quantity of times of prediction for different inputs), θ^{K} is a k^{th} input, c₁ and c₂ are respectively weight coefficients of a maximum margin regularization term R₁(θ) and a manifold regularization term R₂(θ), and an empirical loss CE(θ^{K}) is:

$$CE ( {θ}^{K} ) = - {\sum }_{i = 1}^{\vert B \vert} {α}_{i} \times {y}_{i}^{k} \times log ( {\hat{y}}_{i}^{k} ) ,$$

where |B| is a quantity of behavior classifications (a quantity of types), yr represents a true probability, ŷᵢ^{k} represents a probability predicted by the neural network, and a subscript i represents a individual behavior classification.

The maximum margin regularization term R₁(θ) is:

$${R}_{1} ( θ ) = {\sum }_{k = 1}^{n} max ( 0 , 1 + {max}_{i \neq l} {\hat{i}}_{i}^{k} - {\hat{y}}_{l}^{k} ) .$$

The manifold regularization term R₂(θ) is:

R₂(θ)=tr(FLF^{T}),

where tr( ) is used to calculate a sum of diagonal elements of a matrix in brackets, the matrix F∈R^{|B|×n} includes elements F_{i,k}=ŷᵢ^{k}, and the matrix F^{T} is a transposed matrix of the matrix F. L is a weighted Laplacian matrix, and L=D-W, where D is a vertex degree matrix (only including n item vertexes, other vertexes only participating in calculation, and not being represented) of an interactive map formed by historical behavior data for training, and W is a weighted adjacency matrix. Parameters c₁, c₂, and αᵢ may each be obtained by means of designation, experiment, statistics, training, and the like.

A classification behavior vector sequence of classification behaviors of a target user and a vector representation of a candidate item may be used as an input of the trained neural network, and corresponding classification behavior probabilities, that is, corresponding probabilities each for the target user to perform behavior of each behavior classification on the candidate item, as an output of the neural network is obtained by using the neural network.

FIG. 12 shows an example of such a neural network. As shown in FIG. 12, in this example, such a neural network example is referred to as a broad behavior-aware network 1200, input to the broad behavior-aware network 1200 is a classification behavior vector sequence of a target user and a vector representation of a candidate item, and an output includes classification behavior probabilities of a user for the candidate item. A training process of the network is described above. In the example of FIG. 12, the broad behavior-aware network 1200 includes a recurrent neural network 1201 and a fully connected neural network 1202. The recurrent neural network 1201 is configured to receive the classification behavior vector sequence of the target user as the input and output a vector representation of the target user, and the fully connected neural network 1202 is configured to receive the vector representation of the candidate item as the input and the vector representation of the target user from the recurrent neural network 1201 and output classification behavior probabilities of the target user for the candidate item. In FIG. 12, as an example, the shown recurrent neural network 1201 includes a long short-term memory (LSTM) neural network. However, it is to be understood that the recurrent neural network 1201 may alternatively include another recurrent neural network other than the LSTM neural network, e.g., a basic recurrent neural network (RNN) or a gated recurrent unit (GRU).

As shown in FIG. 12, the recurrent neural network 1201 may include a plurality of parts corresponding to classification behavior vector sequences one by one: a first LSTM part 1201a, a second LSTM part 1201b, a third LSTM part 1201c, a fourth LSTM part 1201d, and a fifth LSTM part 1201e, which respectively correspond to behavior classifications of click, like, comment, share, and follow and corresponding classification behavior vector sequences. Although the recurrent neural network 1201 shown in FIG. 12 includes five parts, and each part corresponds to one classification behavior vector sequence, it is to be understood that the recurrent neural network 1201 may include more or fewer parts corresponding to the classification behavior vector sequences. In addition, although each part of the recurrent neural network 1201 shown in FIG. 12 corresponds to one classification behavior vector sequence, it is to be understood that, two or more classification behavior vector sequences may alternatively share (for example, through time division multiplexing) one LSTM part.

In the example of FIG. 12, each LSTM part may include one or more LSTM units. Each classification behavior vector sequence includes a time sequence including one or more vectors, and the LSTM unit corresponding to the LSTM part processes one of the one or more vectors at each time step. An output (for example, a hidden state hₜ and a memory unit state cₜ) of the LSTM unit of each time step is inputted into an LSTM unit of a next time step. That is, at each time step, an input amount of the LSTM unit includes a corresponding vector in the classification behavior vector sequence and an output of an LSTM unit of a previous time step. Each LSTM part uses an output of an LSTM unit of a last time step as an output of the LSTM part, which is referred to as a classification behavior processing vector. Each classification behavior vector sequence is processed by the LSTM part to obtain a corresponding classification behavior processing vector.

Each classification behavior processing vector of the target user and the vector representation of the candidate item are jointly used as an input of the fully connected neural network 1202. In an example, an attention mechanism may be introduced into the fully connected neural network 1202, that is, the classification behavior processing vectors are multiplied by respective weights, products are summed, a sum is used as a vector representation of the target user, and the vector representation of the target user and the vector representation of the candidate item are jointly used as an input of the fully connected neural network 1202. In an example, besides the classification behavior vector sequences, the recurrent neural network 1201 further processes a total behavior vector sequence corresponding to all classification behaviors of the target user, that is, the recurrent neural network 1201 further includes an LSTM part (such as a sixth LSTM part 1201f in FIG. 12) corresponding to the total behavior vector sequence. Different from each individual classification behavior vector sequence that includes vectors of items (that is, an item used as a classification behavior object) corresponding to one behavior classification, the total behavior vector sequence includes a vector sequence formed by arranging vector representations of items corresponding to all behavior classifications in chronological order of occurrence of the behaviors. An operation of processing the total behavior vector sequence by the LSTM part is similar to an operation of processing the classification behavior vector sequence, and details are not described herein again. After being processed by the corresponding LSTM part, the total behavior vector sequence is transformed into a total behavior processing vector. Vector conversion (for example, addition and vector concatenation) may be performed on weighted sum vectors of the total behavior processing vector and classification behavior processing vectors, and an obtained vector is used as a vector representation of the target user. In the example of FIG. 12, weighted sum vectors of a total behavior processing vector and classification behavior processing vectors are concatenated into a vector representation of the target user through vector concatenation (concat). The weights of the classification behavior processing vectors mentioned above are parameters of the neural network 1200, and may be obtained by training the neural network 1200.

The vector representation of the target user and the vector representation of the candidate item may be converted into a vector through various types of vector conversion, to be inputted into the fully connected neural network 1202. In the example of FIG. 12, vector concatenation (concat) is performed on the vector representation of the target user and the vector representation of the candidate item, and an obtained vector is used as an input to the fully connected neural network 1202.

In the example of FIG. 12, input to the fully connected neural network 1202 includes a concatenated vector of the vector representation of the target user and the vector representation of the candidate item, and the output includes each probability for each behavior classification. For example, corresponding to five classification behavior vector sequences of click, like, comment, share, and follow, a click behavior probability, a like behavior probability, a comment behavior probability, a share behavior probability, and a follow behavior probability are outputted. In the example in FIG. 12, besides the foregoing output, the fully connected neural network 1202 may further output another probability: an unlike probability (a probability that the user is unlikely to perform any classification of behaviors), whose value is a value obtained by subtracting other classification behavior probability values from 1.

In FIG. 12, the shown fully connected neural network 1202 includes an input layer 1202a, two hidden layers 1202b and 1202c, and an output layer 1202d. However, it is to be understood that, the fully connected neural network 1202 may include more or fewer hidden layers as required.

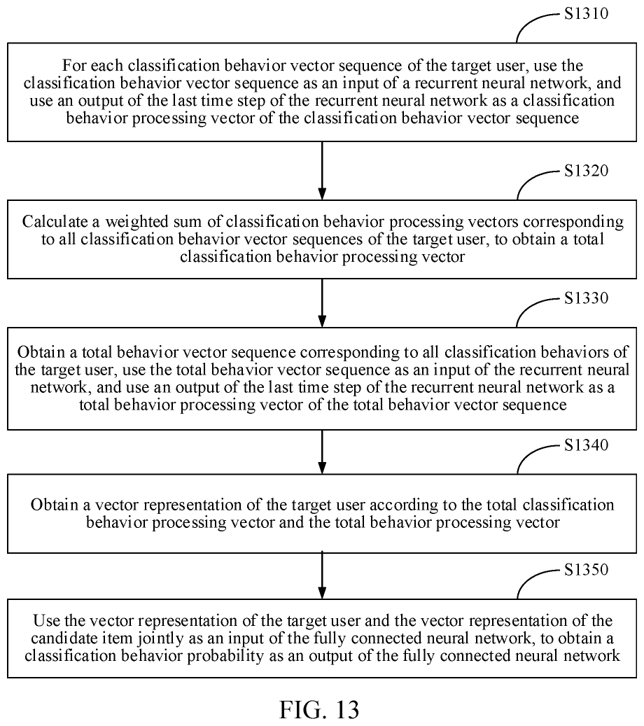

FIG. 13 shows an example of a specific implementation of determining a classification behavior probability of a target user for a candidate item according to a classification behavior vector sequence of the target user and a vector representation of the candidate item based on the broad behavior-aware network 1200 shown in FIG. 12, that is, an example of a specific implementation of step S1010. As shown in the example of FIG. 13, step S1010 may include the following steps.

S1310. For each classification behavior vector sequence of the target user, use the classification behavior vector sequence as an input of a recurrent neural network, and use an output of the last time step of the recurrent neural network as a classification behavior processing vector of the classification behavior vector sequence.

For example, the following classification behavior vector sequences are extracted from historical behavior data of the target user:
a click behavior vector sequence clickseq: {cl₁, cl₂, cl₃, . . . , clₘ};
a like behavior vector sequence likeseq: {li₁, li₂, li₃, . . . , liₙ};
a comment behavior vector sequence commentseq: {co₁, coₜ, co₃, . . . , coₗ};
a share behavior vector sequence shareseq: {sh₁, sh₂, sh₃, . . . , shᵣ}; and
a follow behavior vector sequence followseq: {fo₁, fo₂, fo₃, . . . , foₜ}.

The foregoing five vector sequences are inputted into the recurrent neural network 1201, and each sequence corresponds to one LSTM part. Each LSTM part uses an output of the last time step as a final output, and processes a corresponding vector sequence into corresponding processing vectors, which are respectively a click behavior processing vector CL, a like behavior processing vector LI, a comment behavior processing vector CO, a share behavior processing vector SH, and a follow behavior processing vector FO.

S1320. Calculate a weighted sum of classification behavior processing vectors corresponding to all classification behavior vector sequences of the target user, to obtain a total classification behavior processing vector.

Because the attention mechanism is introduced into the broad behavior-aware network 1200 in FIG. 12, the foregoing five processing vectors are multiplied by respective weights and products are summed, to obtain a total classification behavior processing vector TC.

In an example, the total classification behavior processing vector may be directly used as a vector representation of a target user, and the vector representation of the target user and a vector representation of a candidate item are jointly used as an input of the fully connected neural network 1202. In the example in FIG. 13, the total classification behavior processing vector and the total behavior processing vector obtained in step S1330 are jointly concatenated into the vector representation of the target user.

S1330. Obtain a total behavior vector sequence corresponding to all classifications of behaviors of the target user, use the total behavior vector sequence as an input of the recurrent neural network, and use an output of the last time step of the recurrent neural network as a total behavior processing vector of the total behavior vector sequence.

A total behavior vector sequence (totalseq) {toₚ to₂, to₃, . . . , toₛ} of the target user may be further obtained by using historical behavior data of the target user. It can be learned from the above descriptions about the total behavior vector sequence that composition vectors of the total behavior vector sequence include all composition vectors of the foregoing five classification behavior vector sequences. The total behavior vector sequence is converted into a total behavior processing vector TO by using the corresponding LSTM part (for example, the sixth LSTM part 1201f in FIG. 12) of the recurrent neural network 1201.

Although it is shown in FIG. 13 that step S1330 is after step S1310 and step S1320, it is to be understood that there is no necessary execution order between step S1330 and step S1310 as well as step S1320. Step S1330 may be performed before, after, or at the same time with step S1310 and step S1320.

S1340. Obtain a vector representation of the target user according to the total classification behavior processing vector and the total behavior processing vector.

As shown in FIG. 12, the broad behavior-aware network 1200 performs vector concatenation on the total classification behavior processing vector TC that is obtained in step S1320 and the total behavior processing vector TO that is obtained in step S1330, to obtain the vector representation UA of the target user. It may be understood that, the vector representation UA of the target user may alternatively be obtained according to the total classification behavior processing vector TC and the total behavior processing vector TO through another vector operation.

Although the example shown in FIG. 13 includes step S1330 and step S1340, it is to be understood that, as described above, the total classification behavior processing vector TC obtained in step S1320 may be directly used as the vector representation UA of the target user in another example, and step S1330 and step S1340 may be omitted.

S1350. Use the vector representation of the target user and the vector representation of the candidate item jointly as an input of the fully connected neural network, to obtain a classification behavior probability as an output of the fully connected neural network.

In the example of FIG. 12, the broad behavior-aware network 1200 performs vector concatenation on the vector representation UA of the target user and the vector representation IA of the candidate item, and a concatenated vector is used as an input of the fully connected neural network 1202. It may be understood that, the vector representation UA of the target user and the vector representation IA of the candidate item may alternatively be converted into an input vector of the fully connected neural network 1202 through another vector operation (for example, addition). Alternatively, the vector representation UA of the target user and the vector representation IA of the candidate item may be separately used as two independent inputs of the fully connected neural network 1202.

The fully connected neural network 1202 obtains corresponding classification behavior probabilities based on the input according to the parameters and the model obtained through training. Corresponding to the five classification behaviors in step S1310, five corresponding classification behavior probabilities may be obtained: a click behavior probability CL_P, a like behavior probability LI_P, a comment behavior probability CO_P, a share behavior probability SH_P, and a follow behavior probability FO_P. In addition, in the example of FIG. 12, the unlike probability UNLI_P is further determined.

By using the foregoing examples of specific implementations of step S1010, each classification behavior probability of the target user for the candidate item may be obtained by using the classification behavior vector sequence of the target user and the vector representation of the candidate item.

Referring to FIG. 10, the exemplary method enters step S1020.

S1020. Determine interest of the target user for the candidate item according to the corresponding probabilities each for the target user to perform behavior of each behavior classification on the candidate item.

In step S1020, the interest of the target user for the candidate item is determined according to the classification behavior probabilities obtained in step S1010. In an example, in step S1020, the each classification behavior probability may be directly used as a representation of the interest of the target user for the candidate item. In another example, various conversion operations may be performed on the classification behavior probabilities in step S1020 to obtain the interest.

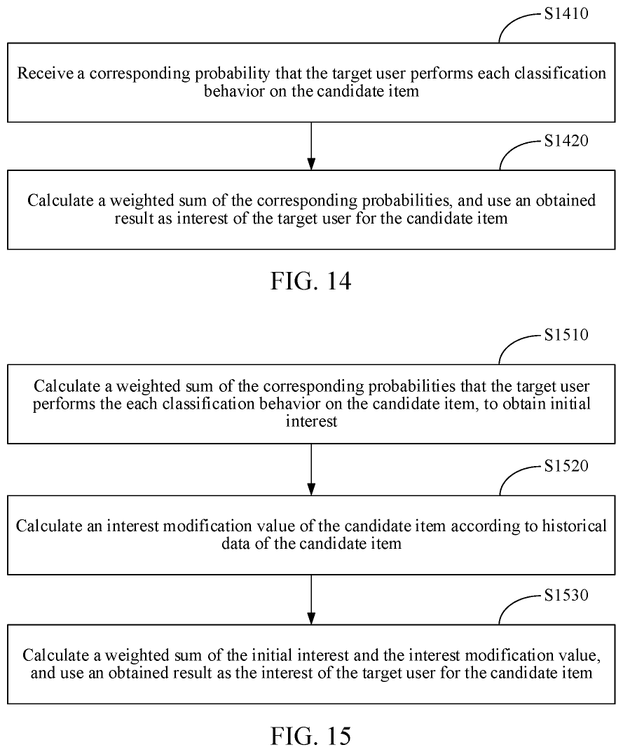

FIG. 14 and FIG. 15 respectively show two examples of specific implementations of how to determine interest according to classification behavior probabilities (that is, step S1020).

In the example in FIG. 14, a weighted sum of classification behavior probabilities is calculated to determine interest. As shown in FIG. 14, step S1020 in this example may specifically include the following steps.

S1410. Receive a corresponding probability that the target user performs each classification behavior on the candidate item.

The interest may be determined in a composition module of the neural network 1200, or may be determined in a module out of the neural network 1200. In step S1410, the interest determining module obtains classification behavior probabilities outputted by the neural network 1200, and calculates a weighted sum of the classification behavior probabilities in step S1420.

S1420. Calculate a weighted sum of the corresponding probabilities, and use an obtained result as interest of the target user for the candidate item.

The interest determining module assigns a given weight value to each classification behavior probability according to an actual meaning of each classification behavior, and calculates a weighted sum of the classification behavior probabilities and the weight values as the interest of the target user for the candidate item. The weight value of the each classification behavior probability may be obtained by means of designation, experiment, statistics, machine learning training, and the like.

In an example, the weighted sum further needs to be adjusted by considering strength of a relationship between the candidate item and the target user, that is, the weighted sum multiplied by an adjustment coefficient is used as the interest. For example, the strength of the relationship between the candidate item and the target user may be determined from the relationship data mentioned above (it is assumed that the candidate item is an entity included in the relationship data). In an example, the adjustment coefficient for the weighted sum may be set to

$$\frac{ρ ( mc , u )}{\vert p ( mc , u ) \vert} ,$$

where ρ(mc, u) is a measure of the candidate item and the target user on the interactive map, that is, the largest product among products of weight values of one or more relationships passing from the candidate item to the target user, and |ρ(mc, u)| is a smallest hop count by which the candidate item and the target user are spaced apart in the relationship data. Therefore, the interest S of the target user for the candidate item may be represented as:

$$S = \frac{ρ ( mc , u ) {\sum }_{i = 1}^{\vert B \vert} ( {ω}_{i} \times {p}_{i} )}{\vert p ( m c , u ) \vert} ,$$

where |B| is a quantity of classification behaviors (a quantity of types), pᵢ is a classification behavior probability, and ωᵢ is a weight value of the classification behavior probability.

In the example of FIG. 15, besides calculating the weighted sum of the classification behavior probabilities, an interest modification value of the candidate item calculated according to a historical recommendation success rate of the candidate item is further introduced. As shown in FIG. 15, step S1020 in this example may specifically include the following steps:

S1510. Calculate a weighted sum of the corresponding probability that the target user performs the each classification behavior on the candidate item, to obtain initial interest.

Step S1510 is similar to step S1420, and details are not described herein again. According to step S1510, the initial interest S₁ may be obtained.

$${S}_{1} = \frac{ρ ( mc , u ) {\sum }_{i = 1}^{\vert B \vert} ( {ω}_{i} \times {p}_{i} )}{\vert p ( m c , u ) \vert}$$

S1520. Determine an interest modification value of the candidate item according to historical data of the candidate item.

A difference between the example shown in FIG. 15 and the example shown in FIG. 14 lies in that a modification value S₂ is further introduced. Specifically, if it is learned through analysis of historical data that a quantity of times that the candidate item is used as a behavior object and/or a quantity of times that the candidate item is recommended are/is relatively small, a specific reward may be given to the candidate item, so that interest of a user for the candidate item obtained through calculation becomes larger, and therefore the candidate item may be appropriately recommended more. Therefore, in an example, the modification value S₂ may be set to:

S₂=exp(−deg(mc)×show(mc)),

where deg(mc) represents a quantity of times that the candidate item has been used as a behavior object in the past, and show(mc) represents a quantity of times that the candidate item has been recommended in the past.

S1530. Calculate a weighted sum of the initial interest and the interest modification value, and use an obtained result as the interest of the target user for the candidate item.

In step S1530, a weighted sum of S₁ and S₂ is calculated to obtain the interest S:

S=β₁×S₁+β₂×S₂,

where β₁ and β₂ are respectively weight values of S₁ and S₂, and may be obtained by means of designation, experiment, statistics, machine learning training, and the like. In an example, β₂ may be set to 1.

According to the foregoing embodiments, interest of a target user for a candidate item may be obtained by using a classification behavior information representation of the target user and an information representation of the candidate item. For each candidate item in a candidate item set, interest of the target user for the each candidate item may be obtained according to the foregoing embodiments, so that the candidate items may be sorted according to magnitudes of the interest. In an exemplary recommendation method, for the candidate items in the candidate item set, higher calculated interest indicates a higher recommendation priority.

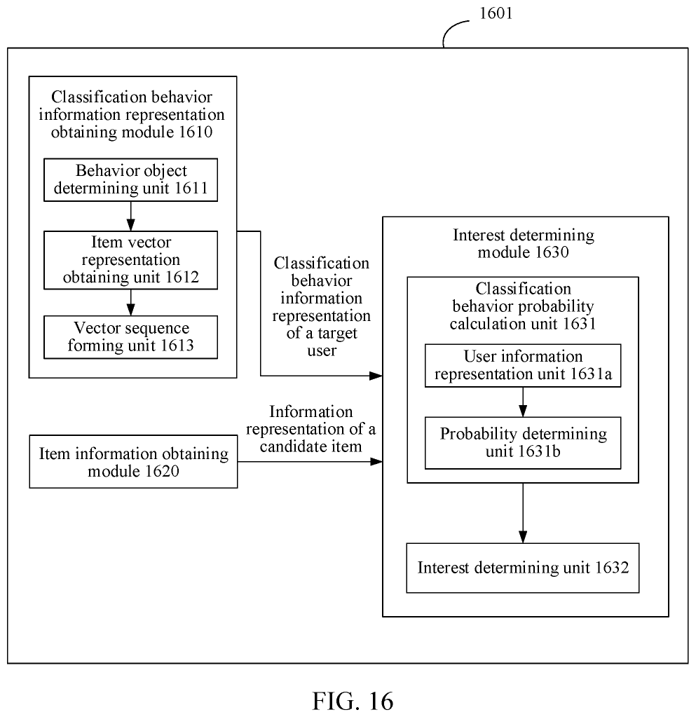

According to another aspect of the present disclosure, an apparatus for determining interest of a user for an item is further provided. The apparatus may perform the foregoing embodiments of the method for determining interest of a user for an item, and may be implemented in the computer device 110 shown in FIG. 1 or may be implemented in another apparatus connected to the computer device 110. FIG. 16 is a schematic component block diagram of such an apparatus according to an exemplary embodiment of the present disclosure. As shown in the embodiment of FIG. 16, the exemplary apparatus 1601 may include:

a classification behavior information representation obtaining module 1610, configured to obtain, according to classification of behaviors of a target user, a classification behavior information representation of each classification behavior of the target user;

an item information obtaining module 1620, configured to obtain an information representation of a candidate item; and

an interest determining module 1630, configured to determine interest of the target user for the candidate item according to the classification behavior information representation of the classification behavior of the target user and the information representation of the candidate item.

In the embodiment shown in FIG. 16, the classification behavior information representation obtaining module 1610 may further include:

a behavior object determining unit 1611, configured to determine, according to historical behavior data of the target user, one or more items used as a behavior object of the each classification behavior of the target user;

an item vector representation obtaining unit 1612, configured to obtain a vector representation of each of the one or more items corresponding to the each classification behavior; and

a vector sequence forming unit 1613, configured to form vector representations of the one or more items corresponding to the each classification behavior into a vector sequence in chronological order of occurrence of the classification behavior, and use the vector sequence as a classification behavior vector sequence of the classification behavior, that is, a classification behavior information representation.

In the embodiment shown in FIG. 16, the interest determining module 1630 may further include:

a classification behavior probability determining unit 1631, configured to determine, according to the classification behavior information representation of the classification behavior of the target user and the information representation of the candidate item, a corresponding probability that the target user performs the each classification behavior on the candidate item; and

an interest determining unit 1632, configured to determine the interest of the target user for the candidate item according to the corresponding probability that the target user performs the each classification behavior on the candidate item.

In the embodiment shown in FIG. 16, the classification behavior probability determining unit 1631 may further include:

a user information representation unit 1631a, configured to obtain an information representation of the target user according to the classification behavior information representation of the classification behavior of the target user; and

a probability determining unit 1631b, configured to determine, according to the information representation of the target user and the information representation of the candidate item, the corresponding probability that the target user performs the each classification behavior on the candidate item.

The implementation and related details of the functions and effects of the various units/modules in the above-described apparatus are described in detail in the implementation of the corresponding steps in the above-described method embodiment and will not be described in detail herein.

The apparatus embodiments in the foregoing embodiments may be implemented by using hardware, software, firmware, or a combination thereof, and may be implemented as an independent apparatus, or may be implemented as a logical integrated system in which composition units/modules are dispersed in one or more computing devices and respectively execute corresponding functions.

The units/modules constituting the apparatus in the foregoing embodiments are divided according to logical functions, and may be re-divided according to logical functions. For example, the apparatus may be implemented by using more or fewer units/modules. The composition units/modules may be separately implemented by using hardware, software, firmware, or a combination thereof. The composition units/modules may be independent components, or may be an integrated unit/module of which a plurality of components are combined to perform a corresponding logical function. The hardware, software, firmware, or a combination thereof may include: a separate hardware component, a function module implemented in a programming manner, a function module implemented through a programmable logic device, or the like, or a combination thereof.

According to an exemplary embodiment, the apparatus may be implemented as a computer device, the computer device includes a memory and a processor, the memory stores a computer program, and the computer program, when executed by the processor, causes the computer device to perform any one of the foregoing method embodiments, or the computer program, when executed by the processor, causes the computer device to implement the functions implemented by the composition units/modules of the foregoing apparatus embodiments.

The processor described in the foregoing embodiment may be a single processing unit such as a central processing unit (CPU), or may be a distributed processor system including a plurality of dispersed processing units/processors.

The memory in the foregoing embodiment may include one or more memories, which may be internal memories of a computing device, for example, various transient or non-transient memories, or may be an external storage apparatus connected to a computing device through a memory interface.

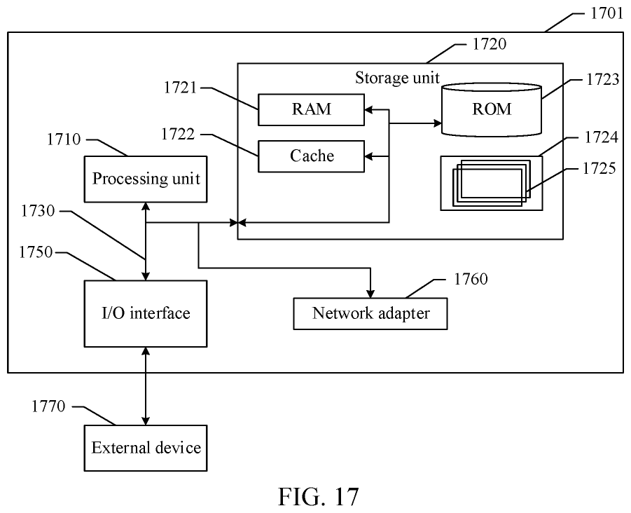

FIG. 17 is a schematic component block diagram of an exemplary embodiment 1701 of such a computer device. As shown in FIG. 17, the computer device may include but is not limited to: at least one processing unit 1710, at least one storage unit 1720, and a bus 1730 connecting different system components (including the storage unit 1720 and the processing unit 1710).

The storage unit stores program code, and the program code may be executed by the processing unit 1710, so that the processing unit 1710 performs the steps according to various exemplary implementations of the present disclosure described in the descriptions of the foregoing exemplary methods of the specification. For example, the processing unit 1710 may perform the steps shown in the flowcharts in the accompanying drawings of this specification.

The storage unit 1720 may include a readable medium in the form of a volatile storage unit, for example, a random access memory (RAM) 1721 and/or a cache storage unit 1722, and may further include a read-only storage unit (ROM) 1723.

The storage unit 1720 may further include a program/utility 1724 having a group of (at least one) program modules 1725. Such a program module 1725 includes, but is not limited to, an operating system, one or more application programs, other program modules, and program data. Each or a combination of these examples may include implementation of a network environment.

The bus 1730 may represent one or more of several types of bus structures, including a storage unit bus or a storage unit controller, a peripheral bus, an accelerated graphics port, a processing unit, or a local bus using any bus structure in a plurality of types of bus structures.

The computer device may alternatively communicate with one or more external devices 1770 (for example, a keyboard, a pointing device, and a Bluetooth device), or may communicate with one or more devices that enable a user to interact with the computer device, and/or communicate with any device (for example, a router or a modem) that enables the computer device to communicate with one or more other computing devices. This communication may be performed by using an input/output (I/O) interface 1750. In addition, the computer device may further communicate with one or more networks (for example, a local area network (LAN), a wide area network (WAN), and/or a public network such as the Internet) by using a network adapter 1760. As shown in the figure, the network adapter 1760 communicates with other modules of the computer device through the bus 1730. It is to be understood that although not shown in the figure, the computer device may be implemented by using other hardware and/or software modules, including but not limited to: microcode, a device driver, a redundancy processing unit, an external magnetic disk drive array, a RAID system, a tape drive, a data backup storage system, and the like.

In one or more of the embodiments of the present disclosure, when interest of a target user for a candidate item is determined or an information representation of a target user is determined, a classification behavior information representation of the target user is introduced. The information representation of the target user is determined according to the classification behavior information representation of the target user, or the interest of a user for the candidate item is determined according to the classification behavior information representation of the target user and an information representation of the candidate item, so that the information representation of the target user includes a classification behavior information representation of the user, or classification behavior information of a user and information about an item are combined to determine interest of the user. Classification behaviors of the user may further include one or more other behaviors besides a click behavior, so that the determining of an information representation and interest of the user can more truly reflect a real situation of the user. In some embodiments, vector representations of items used as classification behavior objects may be arranged into a vector sequence in chronological order of occurrence of classification behaviors, to form a classification behavior vector sequence as a classification behavior information representation, so that the determining of the information representation and the interest of the user fully considers complementarity of item feature information and behavior feature information, fuses the item feature information, the behavior feature information, and time sequence feature information together to form an entire information representation of the user, and therefore is closer to a real situation of the user. In some embodiments, a corresponding probability that a user performs each classification behavior on a candidate item is determined according to a classification behavior information representation of the user and an information representation of the candidate item, thereby determining interest of the user for the candidate item. In this way, the interest is determined not only based on prediction for a click-through rate, but also based on prediction made by comprehensively considering classification behavior probabilities, so that the determined interest is more accurate. In some embodiments, a corresponding probability that the user performs each classification behavior on the candidate item is obtained by using a classification behavior probability prediction model obtained through machine learning. The model is obtained by training a neural network by using historical behavior data, and provides a novel manner of determining interest.

Through the description of the foregoing embodiments, a person skilled in the art can easily understand that the exemplary implementations described herein may be implemented by software, or may be implemented by combining software with necessary hardware. Therefore, the technical solutions of the implementations of the present disclosure may be implemented in the form of a software product. The software product may be stored in a non-volatile storage medium (which may be a CD-ROM, a USB flash drive, a removable hard disk, or the like) or in a network and includes several instructions for instructing a computer device (which may be a personal computer, a server, a terminal device, a network device, or the like) to perform the methods described in the implementations of the present disclosure.

In an exemplary embodiment of the present disclosure, a computer-readable storage medium is further provided, storing computer-readable instructions, and the computer-readable instructions, when executed by a processor of a computer, cause the computer to perform the methods described in the foregoing method embodiments.

According to an embodiment of the present disclosure, a program product for implementing the methods in the foregoing method embodiments is further provided. The program product may use a portable compact disc read-only memory (CD-ROM) and include program code, and may be run on a terminal device such as a personal computer. However, the program product of the present disclosure is not limited thereto. In this file, the readable storage medium may be any tangible medium including or storing a program, and the program may be used by or in combination with an instruction execution system, apparatus, or device.

The program product may be any combination of one or more readable media. The readable medium may be a readable signal medium or a readable storage medium. The readable storage medium may be, for example, but not limited to, an electric, magnetic, optical, electromagnetic, infrared, or semi-conductive system, apparatus, or device, or any combination thereof. More specific examples (non-exhaustive list) of the readable storage medium may include: an electrical connection having one or more wires, a portable disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any appropriate combination thereof.

The computer-readable signal medium may include a data signal transmitted in a baseband or as part of a carrier, and stores readable program code. The propagated data signal may be in a plurality of forms, including, but not limited to, an electromagnetic signal, an optical signal, or any appropriate combination thereof. The readable signal medium may alternatively be any readable medium other than the readable storage medium. The readable medium may be configured to send, propagate, or transmit a program configured to be used by or in combination with an instruction execution system, apparatus, or device.

The program code included in the readable medium may be transmitted by using any suitable medium, including but not limited to, via wireless transmission, a wire, a cable, radio frequency (RF) or the like, or any suitable combination of thereof.

The computer program code configured to execute the operations of the present disclosure may be written by using any combination of one or more program design languages. The program design languages include an object-oriented program design language such as Java and C++, and also include a conventional procedural program design language such as a “C” or similar program design language. The program code may be completely executed on a user computing device, partially executed on a user device, executed as an independent software package, partially executed on a user computing device and partially executed on a remote computing device, or completely executed on a remote computing device or server. For the case involving a remote computing device, the remote computing device may be connected to a user computing device through any type of network including a local area network (LAN) or a wide area network (WAN), or may be connected to an external computing device (for example, through the Internet by using an Internet service provider).

Although several modules or units of a device for action execution are mentioned in the foregoing detailed descriptions, the division is not mandatory. Actually, according to the implementations of the present disclosure, features and functions of the two or more modules or units described above may be embodied in one module or unit. Conversely, the features and functions of one module or unit described above may be further divided into a plurality of modules or units to be embodied.

In addition, although the steps of the method in the present disclosure are described in the accompanying drawings in a specific sequence, it is not required or does not imply that these steps need to be performed according to the specific sequence, or all shown steps need to be performed to achieve an expected result. Additionally or alternatively, some steps may be omitted, a plurality of steps are combined into one step, and/or one step is decomposed into a plurality of steps for execution, and the like.

Through the description of the foregoing embodiments, a person skilled in the art can easily understand that the exemplary implementations described herein may be implemented by software, or may be implemented by combining software with necessary hardware. Therefore, the technical solutions of the implementations of the present disclosure may be implemented in the form of a software product. The software product may be stored in a non-volatile storage medium (which may be a CD-ROM, a USB flash drive, a removable hard disk, or the like) or in a network and includes several instructions for instructing a computer device (which may be a personal computer, a server, a mobile terminal, a network device, or the like) to perform the methods described in the implementations of the present disclosure.

A person skilled in the art can easily figure out another implementation solution of the present disclosure after considering the specification and practicing the solution that is disclosed herein. The present disclosure is intended to cover any variation, use, or adaptive change of the present disclosure. These variations, uses, or adaptive changes follow the general principles of the present disclosure and include common general knowledge or common technical means, which are not disclosed in the present disclosure, in the technology. The specification and the embodiments are merely for an illustration purpose, and the true scope and spirit of the present disclosure are subject to the claims.

What is claimed is:

1. A method for determining interest of a user for an information item, performed by a computer device, the method comprising:
obtaining, according to behaviors of a plurality of behavior classifications of a target user, a classification behavior information representation including vectorized information of behaviors of each behavior classification of the target user;
obtaining a vectorized information representation of a candidate information item; and
determining interest of the target user for the candidate information item according to the classification behavior information representation of the behaviors of the target user and the vectorized information representation of the candidate information item.

2. The method according to claim 1, wherein the classification behavior information representation comprises at least one classification behavior vector sequence, and wherein obtaining, according to the behaviors of the plurality of behavior classifications of the target user, the classification behavior information representation comprises:
determining one or more information items used as behavior objects of behaviors of each behavior classification of the target user;
obtaining a vector representation of each of the one or more information items corresponding to each behavior classification; and
forming vector representations of the one or more information items into a vector sequence in chronological order of occurrence of the behaviors of the each behavior classification, and using the vector sequence as a classification behavior vector sequence of each behavior classification.

3. The method according to claim 1, wherein determining the interest of the target user for the candidate information item according to the classification behavior information representation and the vectorized information representation of the candidate information item comprises:
determining, according to the classification behavior information representation and the vectorized information representation of the candidate information item, probabilities each for the target user to perform a behavior of each behavior classification on the candidate information item; and
determining the interest of the target user for the candidate information item according to the probabilities.

4. The method according to claim 3, wherein determining the interest of the target user for the candidate information item according to the probabilities comprises:
calculating a weighted sum of the probabilities each for the target user to perform a behavior of each behavior classification on the candidate information item, and using the weighted sum as the interest of the target user for the candidate information item.

5. The method according to claim 3, wherein determining the interest of the target user for the candidate information item according to the probabilities comprises:
calculating a weighted sum of the probabilities each for the target user to perform a behavior of each behavior classification on the candidate information item to obtain an initial interest;
determining an interest modification value of the candidate information item according to historical data of the candidate information item; and
calculating a weighted sum of the initial interest and the interest modification value as the interest of the target user for the candidate information item.

6. The method according to claim 3, wherein determining, according to the classification behavior information representation and the vectorized information representation of the candidate information item, the probabilities comprises:
obtaining an information representation of the target user according to the classification behavior information representation of the target user; and
determining, according to the information representation of the target user and the vectorized information representation of the candidate information item, the probabilities each for the target user to perform a behavior of each behavior classification on the candidate information item.

7. The method according to claim 3, wherein the classification behavior information representation comprises at least one classification behavior vector sequence, the vectorized information representation of the candidate information item comprises a vector representation of the candidate information item, and determining, according to the classification behavior information representation and the vectorized information representation of the candidate information item, the probabilities each for the target user to perform a behavior of each behavior classification on the candidate information item comprises:
using the at least one classification behavior vector sequence and the vector representation of the candidate information item as input to a classification behavior probability prediction model, and;
obtaining the probabilities by using the classification behavior probability prediction model.

8. The method according to claim 7, wherein the classification behavior probability prediction model is obtained by training a neural network using historical behavior data, and wherein using the at least one classification behavior vector sequence of the target user and the vector representation of the candidate information item as input to the classification behavior probability prediction model, and obtaining the probabilities comprise:
using the at least one classification behavior vector sequence and the vector representation of the candidate information item as input to the trained neural network, and obtaining the probabilities from the neural network as an output of the neural network.

9. The method according to claim 8, wherein the neural network comprises a recurrent neural network and a fully connected neural network, and wherein obtaining the probabilities as an output of the neural network comprises:
using the at least one classification behavior vector sequence as an input to the recurrent neural network to obtain a vector representation of the target user as an output of the recurrent neural network; and
using the vector representation of the target user and the vector representation of the candidate information item as input to the fully connected neural network to obtain the probabilities as output of the fully connected neural network.

10. The method according to claim 9, wherein using the at least one classification behavior vector sequence as input to the recurrent neural network to obtain the vector representation of the target user as output of the recurrent neural network comprises:
for each of the at least one classification behavior vector sequence of the target user, using the each of the at least one classification behavior vector sequence as input to the recurrent neural network, and using an output of a last time step of the recurrent neural network as a classification behavior processing vector of the each of the at least one classification behavior vector sequence; and
calculating a weighted sum of classification behavior processing vectors corresponding to all of the at least one classification behavior vector sequence of the target user, and using the weighted sum as the vector representation of the target user.

11. The method according to claim 9, wherein using the at least one classification behavior vector sequence as input to the recurrent neural network to obtain the vector representation of the target user as output of the recurrent neural network comprises:
for each of the at least one classification behavior vector sequence of the target user, using the each of the at least one classification behavior vector sequence as input to the recurrent neural network, and using an output of a last time step of the recurrent neural network as a classification behavior processing vector of the each of the at least one classification behavior vector sequence;
calculating a weighted sum of classification behavior processing vectors corresponding to all of the at least one classification behavior vector sequence of the target user to obtain a total classification behavior processing vector;
obtaining a total behavior vector sequence corresponding to all behaviors of the target user using the total behavior vector sequence as an input to the recurrent neural network, and using output of a last time step of the recurrent neural network as a total behavior processing vector of the total behavior vector sequence; and
obtaining the vector representation of the target user according to the total classification behavior processing vector and the total behavior processing vector.

12. The method according to claim 8, wherein training the neural network by using the historical behavior data comprises:
determining a loss function according to a deviation between corresponding probabilities outputted by the neural network and true probabilities specified by the historical behavior data; and
feeding the determined loss function back to the neural network, to adjust parameters of the neural network to reduce the deviation.

13. A computer device for deter determining interest of a user for an information item, comprising a memory for storing instructions and a processor for executing the instructions to:
obtain, according to behaviors of a plurality of behavior classifications of a target user, a classification behavior information representation including vectorized information of behaviors of each behavior classification of the target user;
obtain a vectorized information representation of a candidate information item; and
determine interest of the target user for the candidate information item according to the classification behavior information representation of the behaviors of the target user and the vectorized information representation of the candidate information item.

14. The computer device according to claim 13, wherein the classification behavior information representation comprises at least one classification behavior vector sequence, and wherein to obtain, according to the behaviors of the plurality of behavior classifications of the target user, the classification behavior information representation, the processor is configured to execute the instructions to:
determine one or more information items used as behavior objects of behaviors of each behavior classification of the target user;
obtain a vector representation of each of the one or more information items corresponding to each behavior classification; and
form vector representations of the one or more information items into a vector sequence in chronological order of occurrence of the behaviors of the each behavior classification, and using the vector sequence as a classification behavior vector sequence of each behavior classification.

15. The computer device according to claim 13, wherein to determine the interest of the target user for the candidate information item according to the classification behavior information representation and the vectorized information representation of the candidate information item, the processor is configured to execute the instructions to:
determine, according to the classification behavior information representation and the vectorized information representation of the candidate information item, probabilities each for the target user to perform a behavior of each behavior classification on the candidate information item; and
determine the interest of the target user for the candidate information item according to the probabilities.

16. The computer device according to claim 15, wherein to determine, according to the classification behavior information representation and the vectorized information representation of the candidate information item, the probabilities, the processor is configured to execute the instructions to:
obtain an information representation of the target user according to the classification behavior information representation of the target user; and
determine, according to the information representation of the target user and the vectorized information representation of the candidate information item, the probabilities each for the target user to perform a behavior of each behavior classification on the candidate information item.

17. The computer device according to claim 15, wherein the classification behavior information representation comprises at least one classification behavior vector sequence, the vectorized information representation of the candidate information item comprises a vector representation of the candidate information item, and wherein to determine, according to the classification behavior information representation and the vectorized information representation of the candidate information item, the probabilities each for the target user to perform a behavior of each behavior classification on the candidate information item, the processor is configured to execute the instructions:
use the at least one classification behavior vector sequence and the vector representation of the candidate information item as input to a classification behavior probability prediction model, and;
obtain the probabilities by using the classification behavior probability prediction model.

18. The computer device according to claim 17, wherein the classification behavior probability prediction model is obtained by training a neural network using historical behavior data, and wherein to use the at least one classification behavior vector sequence of the target user and the vector representation of the candidate information item as input to the classification behavior probability prediction model, and to obtain the probabilities, the processor is configured to execute the instructions to use the at least one classification behavior vector sequence and the vector representation of the candidate information item as input to the trained neural network, and obtaining the probabilities from the neural network as an output of the neural network.

19. The computer device according to claim 18, wherein the neural network comprises a recurrent neural network and a fully connected neural network, and wherein to obtain the probabilities as an output of the neural network, the processor is configured to execute the instructions to:
use the at least one classification behavior vector sequence as an input to the recurrent neural network to obtain a vector representation of the target user as an output of the recurrent neural network; and
use the vector representation of the target user and the vector representation of the candidate information item as input to the fully connected neural network to obtain the probabilities as output of the fully connected neural network.

20. A non-transitory computer-readable storage medium for storing instructions, wherein the instruction when executed by a processor are configured to cause the processor to determine interest of a user for an information item by:
obtaining, according to behaviors of a plurality of behavior classifications of a target user, a classification behavior information representation including vectorized information of behaviors of each behavior classification of the target user;
obtaining a vectorized information representation of a candidate information item; and
determining interest of the target user for the candidate information item according to the classification behavior information representation of the behaviors of the target user and the vectorized information representation of the candidate information item.
